(19) United States
(12) Patent Application Publication
(10) Pub. No.: US 2008/0146311 A1
(43) Pub. Date: Jun. 19, 2008

(54) INCREMENTAL REVELATION OF RESULTS IN A GAME OF CHANCE

(76) Inventors: Jay S. Walker, Ridgefield, CT (US); James A. Jorasch, New York, NY (US); Russell P. Sammon, San Francisco, CA (US); Gregory J. Scribner, New Milford, CT (US)

Correspondence Address: WALKER DIGITAL MANAGEMENT, LLC, 2 HIGH RIDGE PARK, STAMFORD, CT, 06905, US

(21) Appl. No.: 11/735,231

(22) Filed: Apr. 13, 2007

Related U.S. Application Data
(60) Provisional application No. 60/868,470, filed on Dec. 4, 2006.

(51) Int. Cl. A63F 13/00

(52) U.S. Cl. 463/20; 463/40

(57) ABSTRACT

The game of roulette is improved by extending the suspense induced in players. The heightened suspense is effectuated by providing partial information regarding game outcomes to the players. The partial information is information from which the player may better guess the actual result without being informed explicitly of the actual result. Ancillary to this technique of providing information about the actual result, players may be afforded additional opportunities to wager or change their wager after provision of such partial information. Eventually, the actual result is revealed to the player and accounting for the winning and losing wagers occurs.

### RELATED APPLICATIONS

The present application claims the benefit of and priority to U.S. Provisional Patent Application Ser. No. 60/868,470, filed Dec. 4, 2006, which is hereby incorporated by reference in its entirety.

The present application is further related to U.S. Patent Publication No. 2003/0220133 filed Dec. 20, 2002, which is also incorporated by reference in its entirety.

### FIELD OF THE INVENTION

The present disclosure relates to a game of chance and more particularly to increasing the suspense attainable during revelation of a result within a game of chance.

### BRIEF DESCRIPTION OF THE DRAWINGS

FIG. 1 illustrates a top plan view of a conventional roulette table including a wheel and betting felt.

FIG. 2 illustrates a side perspective view of a conventional electronic roulette table including wheel, croupier station, and player stations.

FIG. 3 illustrates a block diagram of a system of devices adapted for use in a gaming establishment that facilitates use of some of the embodiments of the present invention.

FIG. 4 illustrates an exemplary player kiosk for use with some embodiments of the present invention.

FIG. 5 illustrates an exemplary a block diagram of a mobile terminal system adapted for use with some embodiments of the present invention.

FIG. 6 illustrates a flow chart of an exemplary embodiment of the methodology of the present invention.

FIGS. 7-23 illustrate exemplary screen shots of various stages within the method of FIG. 6.

### DETAILED DESCRIPTION OF THE INVENTION

The present disclosure capitalizes on the popularity of roulette and provides new opportunities for roulette players to experience the game of roulette. In particular, the present disclosure explains how players may play roulette from a position physically removed from the roulette table through the use of player kiosks and mobile terminals. In an exemplary embodiment, the player places a wager on a roulette table whose precise identity and/or location the player does not know. The roulette wheel is spun, and an actual result is generated i.e., the ball falls into a cup which indicates the actual result or a random number is generated which corresponds to the same event through a look up table or the like. The player is then provided information about the actual result, but the provided information is incomplete such that based on the information, the player does not know what the actual result is. The use of this partial information lengthens the time the player must wait before knowing the actual result. During this lengthened time frame, the player may experience anxiety and a desire to know whether she placed a successful wager.

An example is illustrative. A player sitting at the casino pool deck places a wager through a mobile terminal on a game of roulette and particularly on the number sixteen, which is a red number. In the casino pit, where the roulette tables are located, the roulette wheel on which the wager has been placed is spun. The ball lands in the cup for number 18, which is a red number. Instead of immediately displaying the actual result of eighteen to the player, the system reveals a series of partial results to the player. For example, the player is told the result is a red number. The player may think that it is now more likely that the player has placed a winning wager. The player anxiously awaits further information. A second partial result may be provided. For example, the player is told the result is an even number. Again, the player may experience heightened anticipation associated with awaiting the revelation of the actual result. Finally, the player is informed of the actual result, i.e., eighteen, and told that the player made a losing wager.

While the present disclosure focuses primarily on roulette, the concepts disclosed herein may be modified to work with other games of chance such as baccarat, craps, pai gow, poker, blackjack, keno, bingo and slot machines. For the sake of clarity, a few definitions are provided to assist in understanding some distinctions between the various games and how the novel concepts disclosed herein extend to the various games.

An “outcome” as defined herein is the final disposition of a game that fully informs the player as to what wagers are winners and what wagers are losers. Exemplary outcomes include: the final count on the dice in craps; the number and color in roulette; the final hand in poker; a bust in blackjack; a dealer seven compared to a player eight in baccarat; and the like. In each instance, the player knows completely what wagers are winners or losers.

A “result” as defined herein is a constituent component of an outcome. A set of results forms the outcome. The set of results may be a set of one. Only if the set of results is a set of one result does the result merge with the outcome. In all other instances, a plurality of results forms the outcomes. For example, in roulette, the result of the ball landing in a particular cup is also the outcome of the color and number of the cup into which the ball lands. In contrast, other outcomes include a plurality of results. For example, each card (both for the dealer and the player) in blackjack is its own result. The cards are then combined to provide the outcome. Likewise, in poker, each card including suit and rank is its own result. In craps, the count on each die is a result. The counts on the two dice are combined into the outcome. In bingo, each number-letter combination is a result. In keno, each number is a result, the twenty numbers drawn are then combined into the outcome. In Baccarat, each card is its own result. In slots, the particular image that lies on a payline for each reel is a result. The other images on the payline are then combined to form the outcome. In many games, the outcome, even if it includes multiple results, is a function of a single random event. For example, slots and video poker typically determine a single random number with a random number generator, and each constituent component of the outcome (i.e., each result) is based on that single random number. In other games, such as roulette, each result is a function of its own random event. For example, the result in roulette is based on the single random event of where the ball lands. In craps, the result of each die is based on its own random event. In Pai Gow, the result is the number of dots on each tile.

An “actual result” as used herein is information necessary and sufficient to know fully what the result is. In poker, the actual result of a card would include suit and rank. In roulette, number and color provide the actual result. Again, in some games, the actual result will inform the player without ambiguity what the outcome is. In other games, a plurality of actual results is required to determine the outcome.

A “potential result” as used herein is an actual result that could result from game play. For example, in roulette, each number zero through thirty-six (plus potentially double zero in U.S. roulette), is a potential result. In a card game, each card is a potential result.

A “partial result” as defined herein is partial, but incomplete information about a result which leaves uncertain what the actual result is. For example, in roulette, a partial result may be that the result is red. In blackjack, a partial result may be that the result is less than ten. In poker, a partial result may be that the result is a black card. Numerous other examples are provided in the present disclosure.

Thus, using these definitions, the present disclosure indicates how to reveal partial results to a player so that the player does not know the actual result. Since the player does not know the actual result, the player does not know the outcome and is kept in a state of heightened awareness and suspense until the actual result is revealed. Even after the actual result is revealed, in some games, the player may not know the outcome until other actual results are revealed.

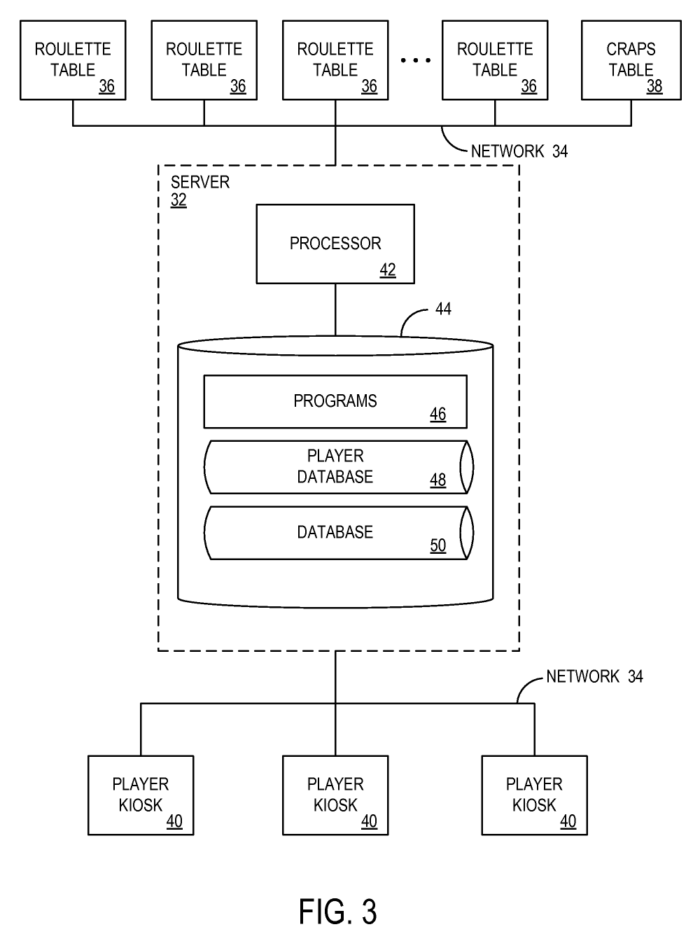

Before addressing particulars of exemplary embodiments of the system and methodology of the present disclosure, a review of conventional roulette tables is provided. These conventional roulette tables may be used with embodiments of the present disclosure as further explained below with reference to FIG. 3.

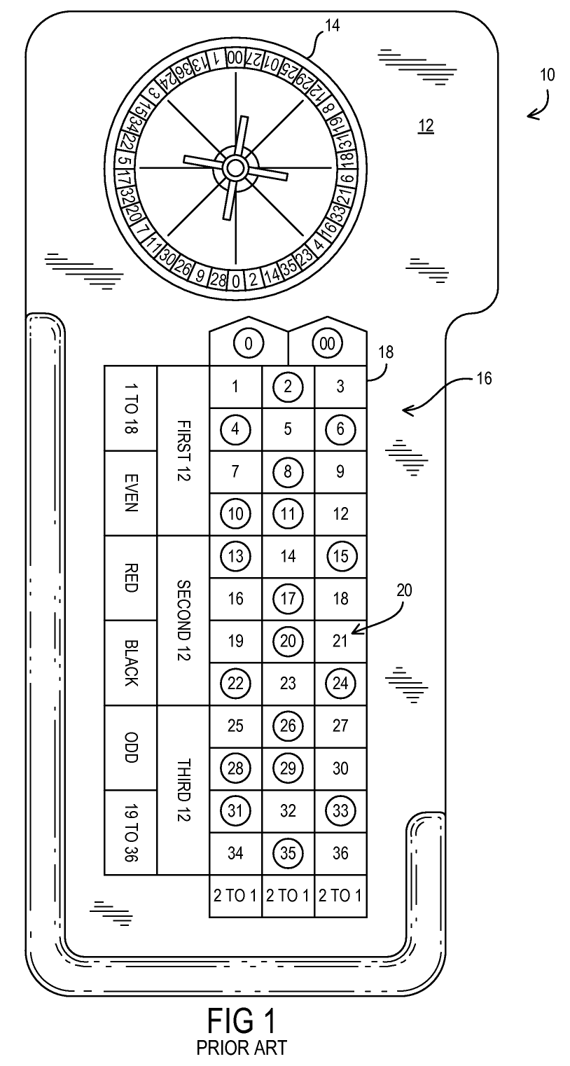

FIG. 1 illustrates a plan view of a conventional roulette table 10. The roulette table 10 typically has a planar surface 12 on which a roulette wheel 14 is positioned in such a manner that the roulette wheel 14 may spin freely as is well understood. A betting field 16 is disposed opposite the roulette wheel 14 and includes indicia 18 that delimit individual bet options 20.

In practice, players purchase chips from the croupier and place bets by positioning their chips relative to the indicia 18 such that a bet option 20 is selected. The croupier spins the roulette wheel 14 and introduces a ball thereinto. The ball moves around the wheel 14 in a direction opposite the rotation of the wheel 14. Friction slows the ball until it falls into a labeled cup on the wheel 14 as is well understood. The croupier collects the chips from the losing wagers and dispenses chips for the winning wagers. The process then repeats. Some tables have a historical outcomes display that lists outcomes from previous spins. For example, outcomes for the last ten spins may be displayed. While each spin is independent of every other spin, some players may use this historical outcome listing to assist them in guessing which numbers are “due” or which numbers are “hot”.

There are two generally recognized styles of roulette wheels 14, namely U.S. and European. The difference between the two styles is that the U.S. style roulette wheel includes the numbers zero through thirty-six and a double zero. In contrast, the European style roulette wheel includes just numbers zero through thirty-six. Roulette wheel 14, as illustrated, is a U.S. style roulette wheel, and the present disclosure focuses on the U.S. style of a roulette wheel, but the teachings set forth herein are generally applicable to a European wheel. Note that the number placement differs between the U.S. style and the European style.

Conventional betting options presented on the table 10 include the numbers individually (a straight or straight up bet), even, odd, red, black, low (numbers one through eighteen), high (numbers nineteen through thirty-six), first twelve (numbers one through twelve), second twelve (numbers thirteen through twenty-four), third twelve (numbers twenty-five through thirty-six), first column (numbers one, four, seven, ten, thirteen, sixteen, nineteen, twenty-two, twenty-five, twenty-eight, thirty-one, and thirty-four), second column (numbers two, five, eight, eleven, fourteen, seventeen, twenty, twenty-three, twenty-six, twenty-nine, thirty-two, and thirty-five), and third column (numbers three, six, nine, twelve, fifteen, eighteen, twenty-one, twenty-four, twenty-seven, thirty, thirty-three, and thirty-six). Each of these bet options has explicit indicia 18 on the table 10.

There are other conventional wagers that do not have specific indicia, but whose import is known to roulette players. A split bet is a wager on two numbers that appear next to one another in the indicia 18. This wager is denoted by placing a chip on the line between the two bet options (e.g., the line between one and four or twenty-nine and thirty). A street bet (sometimes called a row bet) is a wager on three numbers on the same row. This wager is denoted by placing a chip outside the row of numbers on which the wager rides (e.g., to wager on one-two-three, the chip is placed on the line that is the outside edge of the three). A corner bet is a wager on four adjoining numbers as designated by the indicia 18. This wager is denoted by placing a chip at the four-way intersection of the four numbers (e.g., at the intersection of thirty-one, thirty-two, thirty-four, and thirty-five). A square bet is a wager on zero, one, two, or three and is denoted by placing the chip at the intersection of zero and three at the corner of a European style wheel. A five number bet is similar to the square bet, but adds the double zero. This wager is denoted by placing a chip at the intersection of zero and one, on the corner. A line bet is in essence wagering on two streets or rows. This wager is denoted by placing a chip on the outer intersection of the two rows in question (e.g., to bet on seven through twelve, a chip would be placed at the outer intersection of nine and twelve).

As a note of nomenclature, the roulette bets set forth above are sometimes divided into two categories called inside bets which include straight, split, street, corner, five, and line bets and outside bets which include red/black, odd/even, low/high, columns, and dozens.

French roulette (which uses the European style wheel 14) has a number of called bets that are honored by some gaming establishments. These bets are not typically designated by indicia 18, but may be explicitly set forth on certain tables. One called bet is the “voisins de zero” or “neighbors of zero” which covers the arc of numbers around the zero on the wheel. Note that since wheel 14 is a U.S. style wheel, the illustrated numbers do not match up with the recited numbers herein; however, on an actual European style wheel, this arc of numbers includes twenty-two, eighteen, twenty-nine, seven, twenty-eight, twelve, thirty-five, three, twenty-six, zero, thirty-two, fifteen, nineteen, four, twenty-one, two, and twenty-five. When selected, nine chips (or a multiple thereof) are placed, two each on the intersection of zero/two/three and twenty-five/twenty-six/twenty-eight/twenty-nine and one each on four/seven, twelve/fifteen, eighteen/twenty-one, nineteen/twenty-two, and thirty-two/thirty-five. A second called bet is the “Tier du Cylindre” and covers twelve numbers with six chips (or a multiple thereof), two numbers per chip. The numbers are twenty-seven, thirteen, thirty-six, eleven, thirty, eight, twenty-three, ten, five, twenty-four, sixteen, and thirty-three. A third called bet is the “Orphelins” or “Orphans” which is a bet on the bow-tied shaped middle section of the wheel not covered by the Voisins or Tier called bets. The numbers covered are seventeen, thirty-four, six, one, twenty, fourteen, thirty-one, and nine. When selected five chips are bet. These five chips will cover the number one with one chip and the numbers six/nine, fourteen/seven, seventeen/twenty, and thirty-one/thirty-four, each with one chip. A fourth called bet is a “number and neighbor” bet which bets on the number and two neighboring numbers on each side relative to the wheel 14. It takes five chips (or a multiple thereof) to cover this wager (one for each number in the bet). A fifth called bet is a “final bet”. This wager covers all numbers with the same last number (e.g., four, fourteen, twenty-four, and thirty-four). It takes four chips (or a multiple thereof) to cover this wager. Typically, only numbers one through six are eligible for final bets because numbers seven-nine only have three instances on the wheel.

A summary of the conventional wagers and the odds are presented below in table 1.

TABLE 1

| | Number of | | |
|---|---|---|---|
| Wager Name | Numbers Covered | Odds | |
| Straight Up Bet | 1 | 35:1 | |
| Split Bet | 2 | 17:1 | |
| Street (row) Bet | 3 | 11:1 | |
| Corner Bet | 4 | 8:1 | |
| Square Bet | 4 (0, 1, 2, 3) | 8:1 | |
| Five Number Bet | 5 (0, 00, 1, 2, 3) | 6:1 | |
| Line Bet | 6 | 5:1 | |
| Dozens | 12 | 2:1 | |
| Columns | 12 | 2:1 | |
| Low/High | 18 | 1:1 | |
| Odd/Even | 18 | 1:1 | |
| Red/Black | 18 | 1:1 | |
| Voisins de Zero | 17 | 0, 2, 3 | 11:1 |
| | | 25, 26, 28, 29 | 8:1 |
| | | 4, 7, 12, 15, 18 | 17:1 |
| | | 19, 21, 22, 32, 35 | 17:1 |
| Tier du Cylindre | 12 | 17:1 | |
| Orphelins | 8 | 1 | 35:1 |
| | | 6, 7, 9, 14, 17 | 17:1 |
| | | 20, 31, 34 | 17:1 |
| Neighbor | 5 | 35:1 | |
| Final | 4 | 8:1 | |

An interesting side effect of the nature of the table 10 is that roulette chips usually have no value denomination printed on the chip. Rather, the table 10 comes with sets of different colored chips, each usually consisting of three hundred chips of that color. When a player buys-in, the player gets her own color, and the value of an individual chip is determined by dividing the buy-in by the number of chips the player receives. For example, a player who buys one hundred chips for five hundred dollars gets one hundred chips each worth five dollars. The croupier typically places a token on top of the house stack of that color to indicate the value.

A necessary consequence of the chip scheme of a normal roulette table is that the number of players cannot exceed the number of different colors available at the table. For example, if there are only six colors, then only six players can play at that table. Electronic roulette tables which are not bound by chips allow more players to play simultaneously.

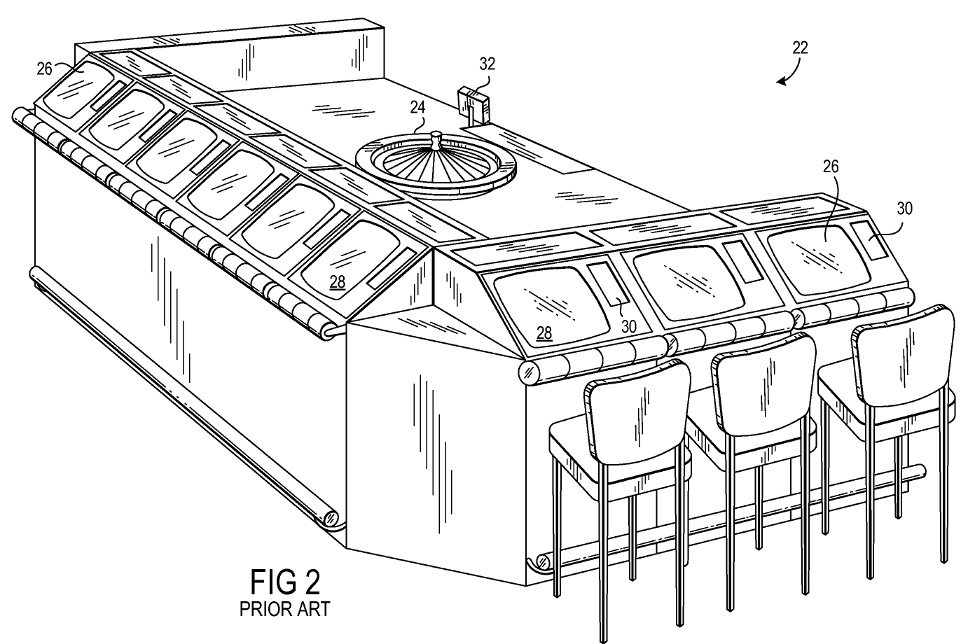

A conventional electronic roulette table 22 is illustrated in FIG. 2. The electronic roulette table 22 includes a wheel 24, which may be European or U.S. style that spins freely. Note that while the wheel 24 is illustrated as a physical wheel, it is possible that the wheel is an electronic wheel presented on a display whose animation is a function of a microprocessor and a random number generator as is well understood. In place of the betting area 16, the electronic roulette table 22 includes a plurality of player terminals 26 which include a display 28 and a user interface 30. Each display 28 presents a video representation of a betting layout essentially identical to betting area 16 complete with indicia 18 and bet options 20. The display 28 may be a touch screen. Players create equity through the user interface 30, such as by inserting cash into a bill acceptor, using a cashless receipt system, or the like. Establishing equity may create a number of credits that the player may then use to place wagers. Wagers are then made by using the established equity (e.g., betting a certain number of credits) and touching the touch screen or other command functions of the user interface 30. Each player terminal 26 may have its own computer controller, or all the player terminals 26 may be controlled by a single computer controller.

A croupier or other gaming establishment personnel may use a croupier screen 32 to track the wagers as they are made. If the electronic roulette table 22 has a single computer controller, the croupier screen 32 may be operated by that computer controller. Alternatively, the croupier screen 32 may have its own computer controller. For more information about an electronic roulette table 22, the interested reader is referred to U.S. Pat. No. 6,659,866 and U.S. Patent Publication No. 2006/0094493, both of which are incorporated herein by reference in their entireties. Based on these two existing tables, it is readily apparent that there are at least two techniques for generating an outcome in roulette. The outcome may be generated by a physical roulette wheel. Alternatively, the outcome may be generated from some random number generator such as an electronic random number generator. The use of such random number generators is well understood in the industry.

While not illustrated in FIGS. 1 and 2, the roulette tables 10 and 22 may have an electronic controller which is used by the croupiers to facilitate action at the respective roulette tables. For example, payouts may be recorded, player action recorded for rating players, and similar data may be collected and outputs provided to the croupier to facilitate game play. Likewise, payout and probability databases may be available to this computer controller by storing such in a local or remote memory. Such controllers are control systems as that term is further explained below in the section entitled “Rules of Interpretation”. The controllers may be in communication with (i.e., communicatively coupled) a central server 32 through a network 34. The network 34 is a network as that term is explained in the Rules of Interpretation below. This system is illustrated in FIG. 3, wherein roulette tables 36 are in communication with (i.e., communicatively coupled) with to the server 32 via the network 34. In addition to roulette tables 36, one or more craps tables 38 (only one illustrated), other gaming tables (none illustrated), and one or more player kiosks 40 may be connected to the central server 32 via the network 34. As an aside, note that elements that are in communication with one another may be operatively coupled with one another depending on the nature of the devices.

Central server 32 is a server as that term is defined in the Rules of Interpretation below. The server 32 may include a communication port or other network interface (not explicitly shown) adapted to couple operatively the server 32 to the network 34. Furthermore, the server 32 may include a processor 42. The processor 42 may be in communication with memory 44 with programs 46 stored thereon. A player database 48 and other databases 50 may further be stored on the memory 44 as practical or desired. The processor 42 coupled with the programs 46 is a control system as that term is defined in the Rules of Interpretation.

The server 32 may perform some of the functionality attributed to the controllers of the roulette tables 36. That is, the roulette tables 36 may act as client devices for the server 32 with most of the processing and decision making occurring on the server 32. In such an instance, the processor 32 is operatively coupled to the user interface 30 through the network 34 and acts as the control system for the roulette table 36. Other databases 50 (only one shown) may include but are not limited to: a game database that stores information regarding one or more games playable on and/or downloadable to one or more roulette tables 36, craps table 38 or player kiosk 40, and a scheduling and/or configuration database useful for determining which games are to be made available on which tables 36, 38 or kiosk 40 at what times. Such downloads may be used to switch between modes of operation of the table 36, 38 or kiosk 40 if desired. In other embodiments, some or all of these functions may be handled by a device distinct from the server 32, but remotely positioned relative to the tables 36, 38 or kiosk 40.

In place of the payout and probability databases being present in the tables 36, 38, such databases and/or data may instead be stored in the databases 50 of the memory 44. Likewise, the databases may be distributed and/or duplicated between various devices within the network 34 such as player kiosks 40.

The programs 46 may allow the server 32 to track gambling, gaming, or other activity performed at the tables 36, 38 or kiosks 40, track gaming or other activities of individual players, instruct a table 36, 38 or kiosk 40 to perform one or more functions (e.g., output a message to a player, interrupt play, or the like), assign or otherwise determine a unique identifier for a player, and/or control access to stored funds and/or a credit line. In some embodiments the server 32 may be operable to configure a table 36, 38 or kiosk 40 remotely, update software stored on a table 36, 38 or kiosk 40, and/or download software or software components to a table 36, 38 or kiosk 40. For example, the server 32 may be operable to apply a hot fix to software stored on a table 36, 38 or kiosk 40, modify a payout and/or probability table stored on a table 36, 38 or kiosk 40, and/or transmit a new version of software and/or a software component to a table 36, 38 or kiosk 40. The server 32 may be programmed to perform any or all of the above functions as practical or desired and may do so based on, for example, an occurrence of an event (e.g., a scheduled event), receiving an indication from authorized gaming establishment personnel, an authorized third party (e.g., a regulator) and/or receiving a request from a player. In other embodiments, some or all of these functions may be handled by a device distinct from the server 32.

While the previous paragraph describes the server 32 configuring the table 36, 38 or kiosk 40, it is also possible that the server 32 stores games thereon, and these games are requested from the table 36, 38 or kiosk 40. The table 36, 38 or kiosk 40 may be programmed to check periodically if updates are available, and, if an update is available, download and install the update. Alternatively, the table 36, 38 or kiosk 40 may check on occurrence of an event, an indication from authorized gaming establishment personnel, an indication from an authorized third party, or the like. It is particularly contemplated that the table 36, 38 or kiosk 40 may be a thin client controlled by the server 32, although such is not required for operation.

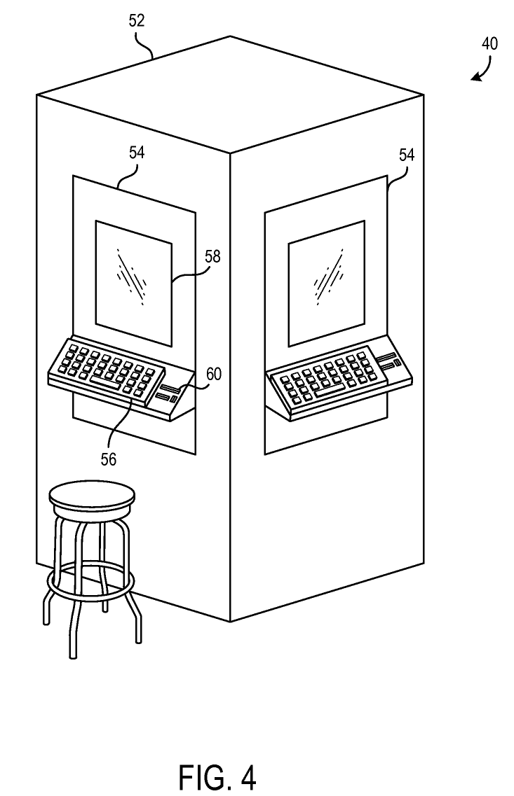

A more detailed explanation of a player kiosk 40 is illustrated in FIG. 4. In an exemplary embodiment, the player kiosk 40 includes a rectilinear cabinet 52 with player terminals 54 disposed on each vertical side. Each player terminal 54 includes a keypad 56, a display 58 and an equity input/output mechanism 60. While illustrated as an upright cabinet, it should be appreciated that the kiosk 40 could be a slant top or bar top style device. Likewise, while illustrated as a multiplayer kiosk, the kiosk 40 could be a single player device. Players may input commands through the keypad 56, view outputs through the display 58 and provide funds or receive payouts through the equity input/output mechanism 60. An exemplary equity input/output mechanism 60 is a bill acceptor and a cashless ticket dispenser as are well understood in the industry. Other arrangements of input devices and output devices are also possible. For example, the display 58 may be a touch screen display, eliminating the need for a separate keypad 56.

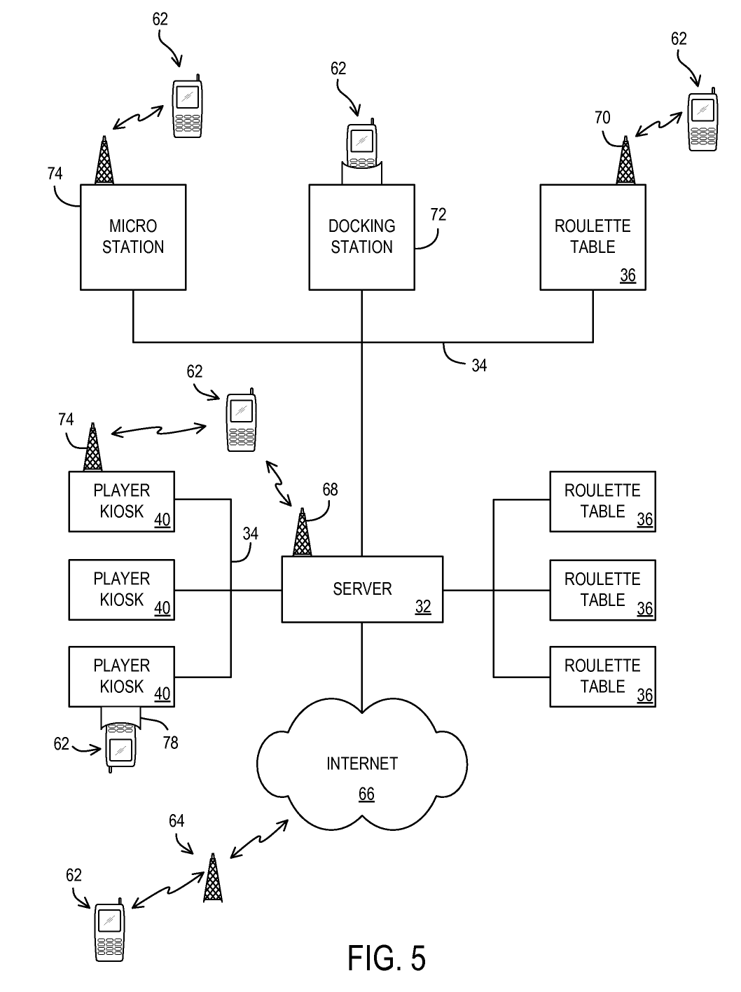

An alternate embodiment of the player kiosk 40 is a mobile terminal 62 (See FIG. 5). While mobile terminal 62 may be a cellular phone, a personal digital assistant (such as a PALM® or BLACKBERRY™0 device), a handheld gaming device (such as a NINTENDO GAMEBOY), a laptop computer, a pager, or the like, for the purposes of this exemplary embodiment, the mobile terminal 62 is a tablet pc such as the LS800 Tablet PC by Motion Computing Inc of Austin Tex. running MICROSOFT WINDOWS XP Tablet PC edition. Another suitable device is the iPAQ hw6920 by Hewlett-Packard Company of Palo Alto, Calif. running MICROSOFT WINDOWS MOBILE for Pocket PC. In short, the mobile terminal 62 may be a device dedicated to gambling or a multipurpose device such as a cellular phone on which games may be played as practical or desired. The mobile terminal 62 includes a user interface including a keypad, microphone, speaker, and display. The mobile terminal 62 further includes a controller or processor with corresponding software stored in a local memory that acts as a control system as that term is defined in the Rules of Interpretation. Alternatively, the user interface of the mobile terminal 62 may be controlled by a remotely positioned control system such as the processor 42.

FIG. 5 illustrates a variety of techniques through which the mobile terminal 62 may be used. The illustrated techniques are intended to be exemplary and non-limiting. In one embodiment, the mobile terminal 62 may communicate through a wireless network 64 (e.g., such as the public land mobile network (PLMN)) to the internet 66, and through the internet 66 to an online casino server (not shown explicitly) or other server 32. In such an embodiment, the mobile terminal 62 may be equipped with a web browser (e.g., FIREFOX, MOZILLA, NETSCAPE NAVIGATOR, INTERNET EXPLORER, etc.) to interoperate with the online casino. While the internet 66 is contemplated, the public switched telephone network (PSTN) or other communication network may be used in place thereof as practical or desired. Alternatively, the mobile terminal 62 may download the game from such a server, and the game may be played locally.

As yet another option, the mobile terminal 62 may instead communicate with elements of the network 34. In one embodiment, the mobile terminal 62 communicates with the server 32 through an antenna 68 coupled to the server 32 using an appropriate wireless protocol. In a second embodiment (not shown), the mobile terminal 62 may dock directly with the server 32 using appropriate docking technology. Note that this embodiment may require appropriate security and firewalls since the player will have essentially direct access to the server 32. In another embodiment, the mobile terminal 62 may communicate with a roulette table 36 through an antenna 70. Note that the antenna 70 may be coupled to the roulette table 36 through a peripheral device. While it is possible that in some embodiments the mobile terminal 62 may communicatively couple to a roulette table through a docking station (not shown), such is not desired as the mobile terminal 62 may in that case be too close for the purposeful obfuscation of the actual result as explained in greater detail below.

In yet another embodiment, a dedicated docking station 72 may be provided, and the mobile terminal 62 may be coupled to the network 34 through the docking station 72. In yet another embodiment, a cellular microstation 74 may be communicatively coupled to the network 34 and the mobile terminal 62 may interoperate with the microstation 74. In still another embodiment, the mobile terminal 62 may communicate with the network 34 through a fixed player kiosk 40, such as via an antenna 76 or through a docking station 78. Other arrangements are also contemplated.

Instead of conducting game play on the mobile terminal 62, the mobile terminal 62 may form part of a user interface. For example, a player may use the display 58 of a player kiosk 40, but issue commands related to game play through the mobile terminal 62, or the player may use input keypad 56 to issue commands, but see results on a display of the mobile terminal 62. Again, the mobile terminal 62 may communicate with the server 32 using any appropriate mechanism.

While not explicitly illustrated in FIG. 5, another type of player kiosk 40 is a personal computer that connects to the server 32 through the internet or other appropriate network. Alternatively, the server 32 may be an online server, and the personal computer interoperate therewith in using protocols and communication techniques used and popularized by online casinos.

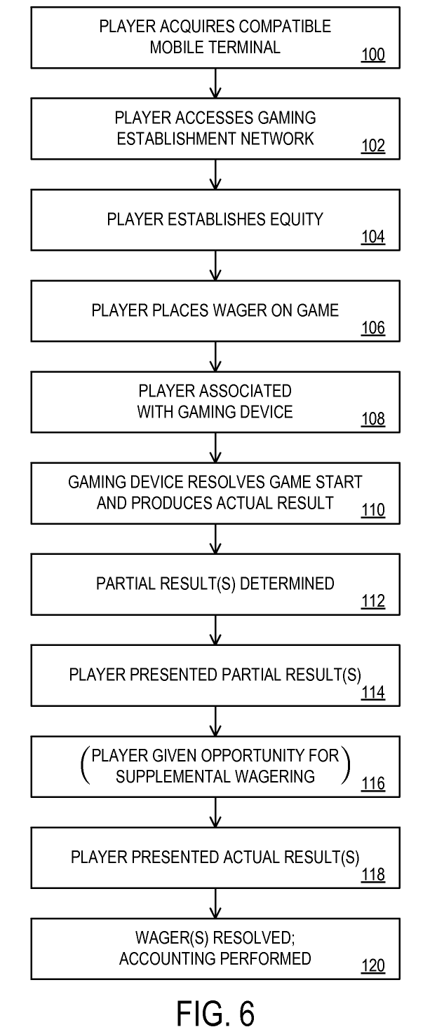

Against this backdrop of hardware, an exemplary method of using this hardware is provided with reference to FIG. 6. The player initially acquires a mobile terminal 62 (block 100). To acquire a mobile terminal 62, the player may bring her own, such as a personal digital assistant or cellular phone; the player may rent one from a gaming establishment; the player may purchase one from the gaming establishment; or other technique as desired. If the player rents a mobile terminal 62, the player may provide a security deposit and/or set up a financial account with the renting establishment as desired.

Once the player is ready, the player accesses the network 34 of the gaming establishment (block 102). The player may do this by docking the mobile terminal 62 in one of the docking stations 72, 78, wirelessly connecting through an antenna, or other technique as desired.

The player then establishes equity with the mobile terminal 62 (block 104). Equity may be established by providing a credit card account number, a financial account number, a hotel room account, providing cash to a casino attendant who creates credit on the mobile terminal 62, inserting cash into a bill or coin acceptor if the mobile terminal 62 is equipped with the same, linking the equity to a cellular phone account, providing a player identifier, inserting a cashless gaming receipt into a reader device if the mobile terminal 62 is equipped with the same, transferring electronic credits from another device, or the like.

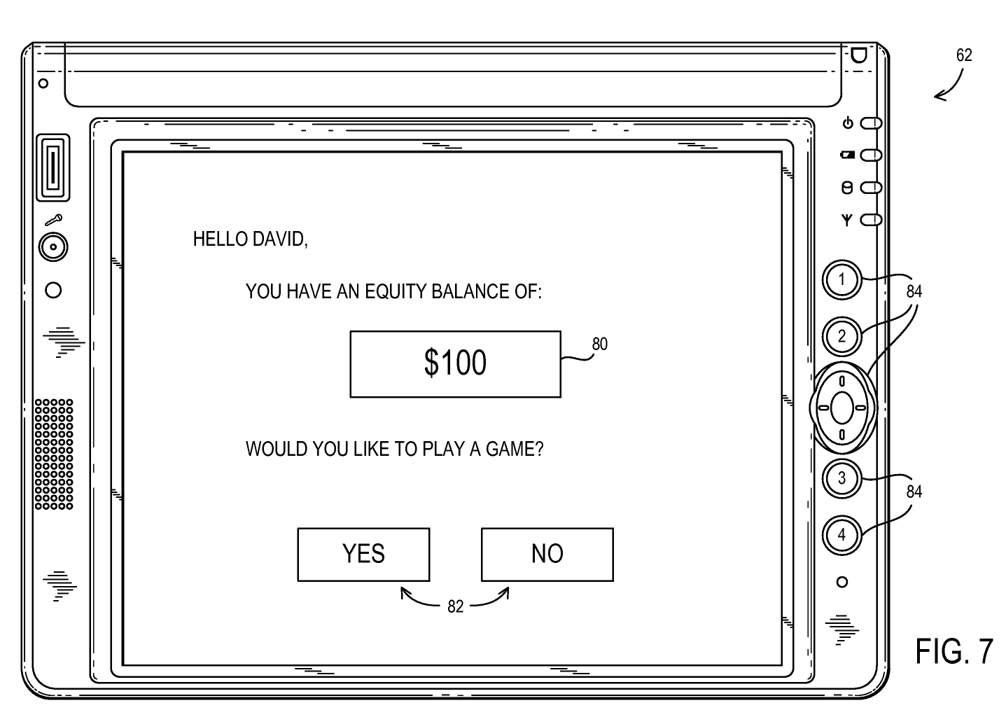

Once the player has equity, the player may be given the opportunity to begin gaming. An exemplary screen shot for the mobile terminal 62 at this stage of the method is illustrated in FIG. 7. Note that the equity balance 80 is displayed along with response buttons 82 that allow the player indicate whether the player would like to play a game. While it is contemplated that the mobile terminal 62 has, in this exemplary embodiment, a touch screen display, other keypad inputs 84 may be used to provide input to the mobile terminal 62.

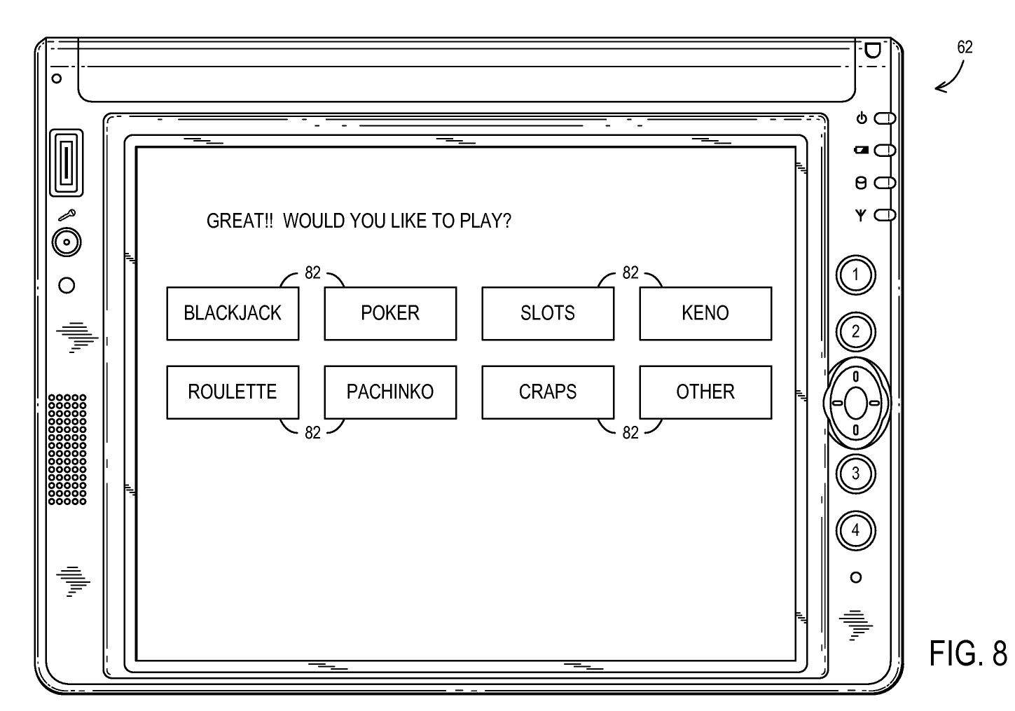

If the player answers the onscreen query affirmatively, then the player may be presented a query as to which game the player would like to play as evidenced by the exemplary screen shot presented in FIG. 8. Note that there are response buttons 82 which allow the player to indicate which game the player would like to play. For the purposes of the example, the player selects Roulette using the appropriate one of the response buttons 82.

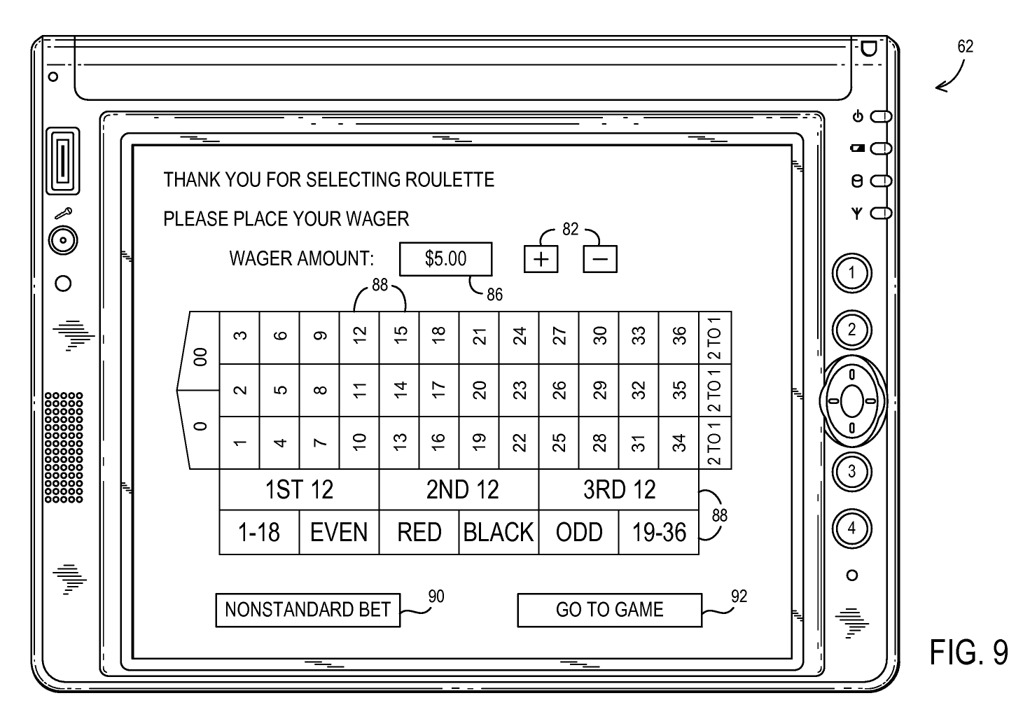

The player is then presented the opportunity to place a wager. An exemplary screen shot of this opportunity is presented in FIG. 9. The player may increase or decrease the wager amount using the plus/minus response buttons 82 until the value in the wager box 86 reflects a desired wager. Once the player is satisfied with the amount of the wager, the player may select a particular number or other wager type using the appropriate wager button 88 on the touch screen to place the wager (block 106). While several standard wagers are illustrated, if the player desires to place a nonstandard wager, the player may press the appropriate nonstandard wager button 90. For more information on nonstandard wagers and customizing this betting felt interface, the interested reader is directed to PCT patent application serial no. PCTUS06/37005, filed Sep. 22, 2006, which is hereby incorporated by reference in its entirety.

The player may place multiple wagers if desired. At some point, the player finishes entering wagers and desires to go to the wager resolution stage of the gambling process. The player may indicate this desire by pressing the “Go to game” button 92. Once the player has indicated that she is ready to go to the game, the player is associated with one of the roulette tables 36 of the gaming establishment (block 108). Note that the player may be associated with a table when acquiring the mobile terminal 62, when establishing equity, or other time point as desired by the gaming establishment.

In an exemplary embodiment, the player does not know with which of the myriad roulette tables 36 the player is associated. By obfuscating with which table 36 the player is associated, the gaming establishment may preclude the player from using any knowledge that watching the associated table 36 may provide. For example, if there are network delays that allow wagers to be entered after betting has closed at the associated table 36, the fact that the player does not know which table is associated with the player precludes the player from using that knowledge purposefully to place a late wager on a known winning outcome. Likewise, if the associated table 36 has revealed the actual result, lack of knowledge of which table is the associated table means that the player does not know the actual result. Reasons for keeping the player from knowing the actual result are explained in greater detail below.

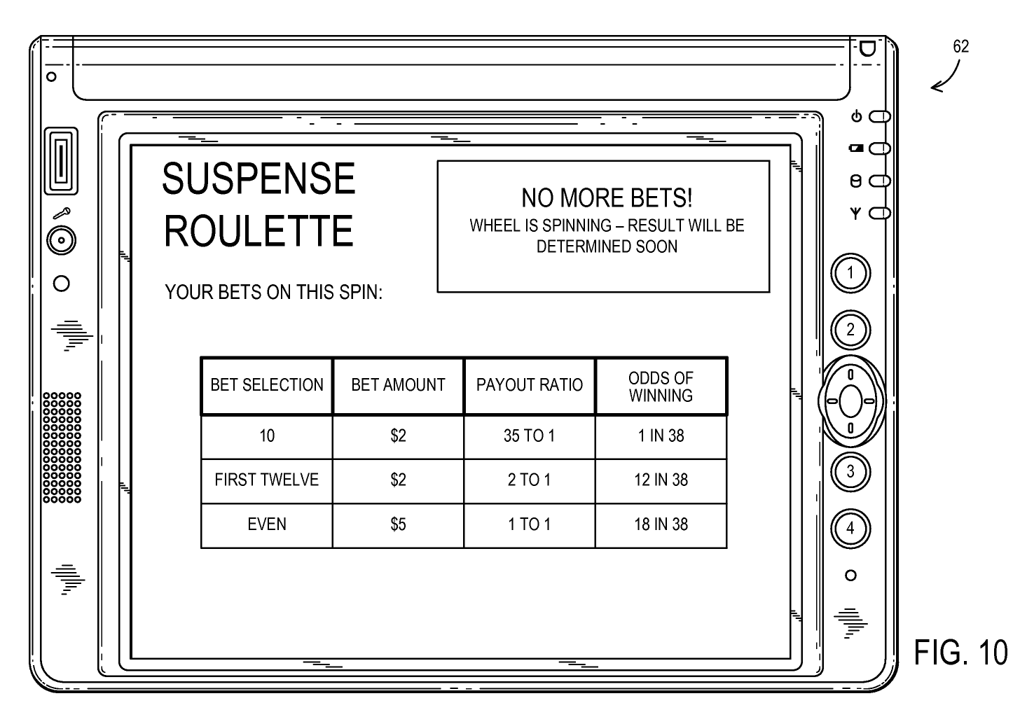

The player may be informed that betting has closed as well as provided a summary of the player's currently pending wagers. See the exemplary screen shot of FIG. 10. The player is likewise informed that the roulette table 36 is determining the actual result. As is well known in the game of roulette, the croupier introduces the ball into the spinning wheel to start the game. The roulette table 36 resolves the game start and produces an actual result (block 110). The croupier may report the actual result to the table controller; a camera may record the actual result; or in the case of an electronic roulette table, the actual result is a function of a random number generated by a random number generator, and this actual result may be reported to the central server 32.

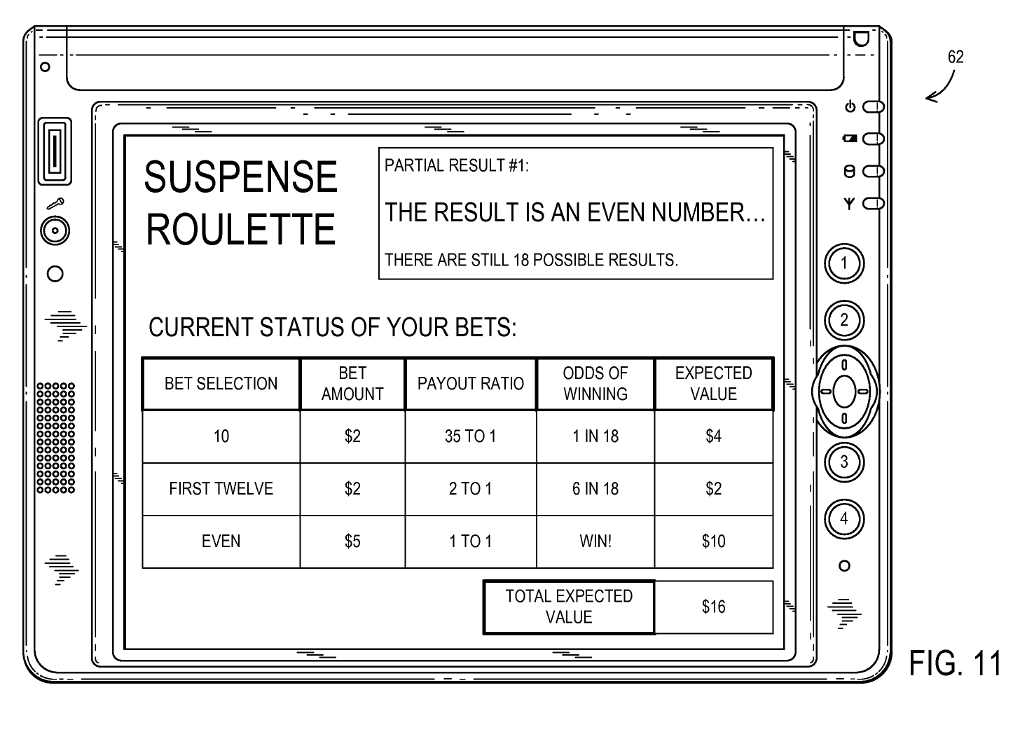

The central server 32 may then determine a partial result from the actual result (block 112) and the player is provided the partial result (block 114). See also FIG. 11, which shows how the player may be provided the partial result through the mobile terminal 62. Note that while it is specifically contemplated that the central server 32 makes this determination, any other control system within the system may make this determination. Further note that provision of the partial result may be in response to a trigger. In a first embodiment, the trigger is the determination of the actual result. In a second embodiment, the trigger is a player request for a partial result. For example, the player may press a button marked “Show me a partial result” or the like. Still other reasons for provision of partial results are provided below, and these examples are not intended to be exclusive.

The term partial result is defined above. However, a few additional examples are provided here so that the term is better understood. For example, a partial result may be that the actual result is even or odd, red or black, low or high, whether the actual result is less than or greater than a threshold number, an indication of one digit of the result number (e.g., the ones digit is a three, but the player does not know if the result is 3, 13, 23, or 33), or the like. In the simplest embodiment, the partial result is determined irrespective of the wager made by the player. In this embodiment, the player may potentially immediately know whether a wager is a winner or loser, even if the player does not know the actual result.

In a more sophisticated embodiment, determination of the partial result takes into account the player's wager and makes an effort to occlude losing wagers from the player's knowledge. For example, as illustrated in FIG. 11, the partial result is that the result is an even number. The player does not know if either of her first two wagers is a losing wager, but the player does know that the last wager is a winning wager. By preventing the player from knowing if the wager is a losing wager, the player may undergo an extended period of suspense, which may in turn, heighten the excitement associated with the game. Note also, that FIG. 11 shows that the even wager made by the player provides an immediate payout for the player since the player knows that it is a winning wager. In a still more sophisticated embodiment, determination of the partial result is based on an overlap of two or more wagers placed by the player. For example, assume the player places two bets, one on even and one on red. The actual result is 14 (black). The partial result is then chosen to be “Result is in the second twelve (13-24).” This partial result allows the player to fantasize about winning both wagers since neither wager has been revealed as a loser.

In an alternate embodiment, in place of the partial result, the player may be provided supplemental information related to an indication of how much money has been won or lost (e.g., you won at least five credits), a ratio of successful wagers by the player (50% of the wagers you placed are winners), or even a ratio of successful wagers at the table (e.g., there are six winning wagers at this table). This information and/or other aggregated or statistical information may be revealed, either as part of the partial result or otherwise as desired.

Note also in FIG. 11, that the player is informed of the expected value of his wagers and the odds of winning on his wager with the new information revealed by the partial result. If the supplemental wager option is enabled, the player may be presented an opportunity to use the supplemental wager function at this time (block 116). More information on the supplemental wager function is provided below.

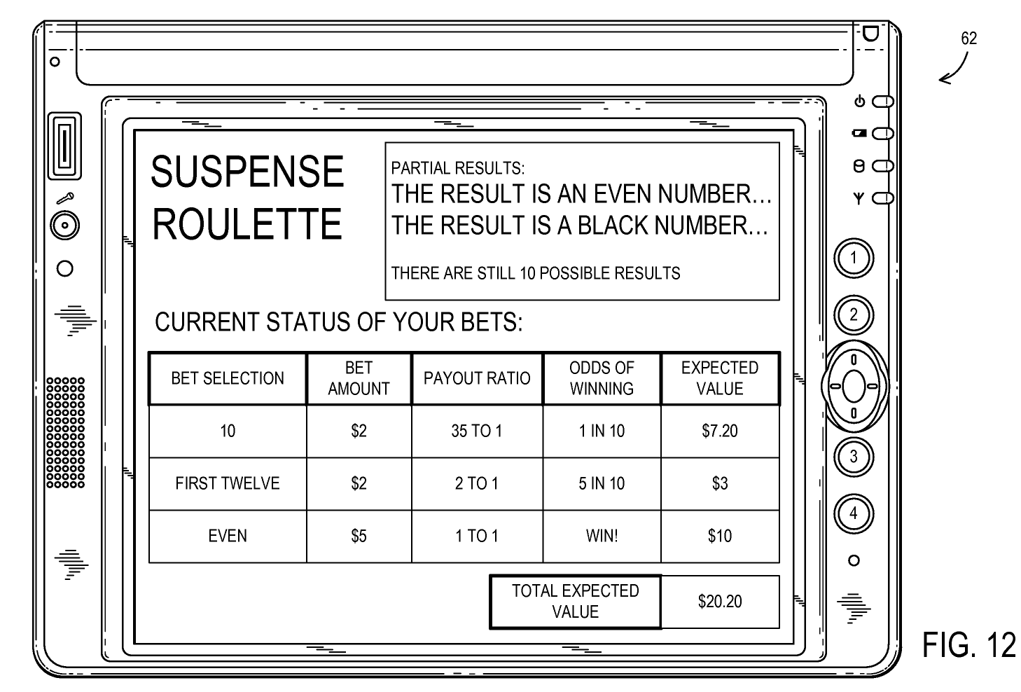

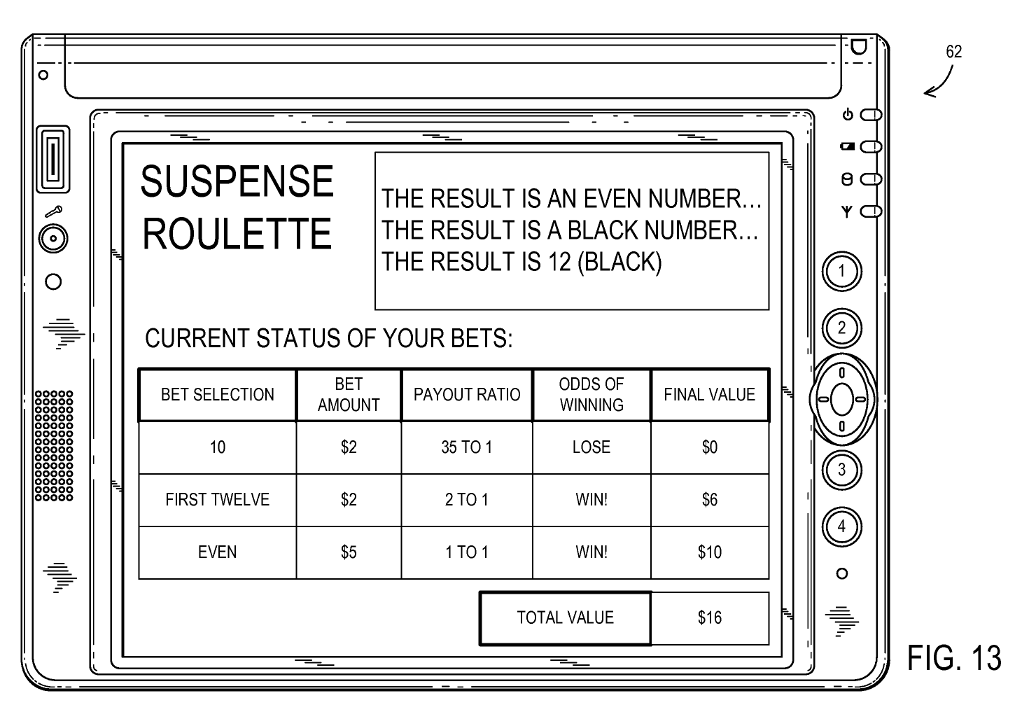

The player may be provided additional partial result information along with updated odds and expected values as illustrated in FIG. 12. Finally, the player is presented the actual result (block 118) and the wagers are resolved with any associated accounting taking place (block 120). An exemplary screen shot is illustrated in FIG. 13. Note that the actual result may be set forth explicitly as a number, a portion of a roulette wheel may be highlighted, a portion of the felt may be highlighted or the information may otherwise be presented to the player. Other possible techniques include a scrolling text message across the screen of the mobile terminal 62 or a video of the associated roulette table 36 may be presented so that the player can see the ball in the cup of the wheel. Such a video may be a video replay presented to the player some time after the actual generation. This delay may be intentional or merely a function of the time required to generate the video and to format the video into a format appropriate for transmission to the mobile terminal 62. The actual result may be presented for a set amount of time sufficient for a player to digest the ramifications of the actual result.

There may be a delay between outputting the partial result and outputting the actual result. This delay may be to give a player time to view the partial result before viewing the actual result. The delay may be for a set amount of time, or the player may provide an indication that she is done viewing the partial result. Exemplary command buttons may state “I am done viewing this partial result” or “Show me the actual result” or “Show me the next partial result”.

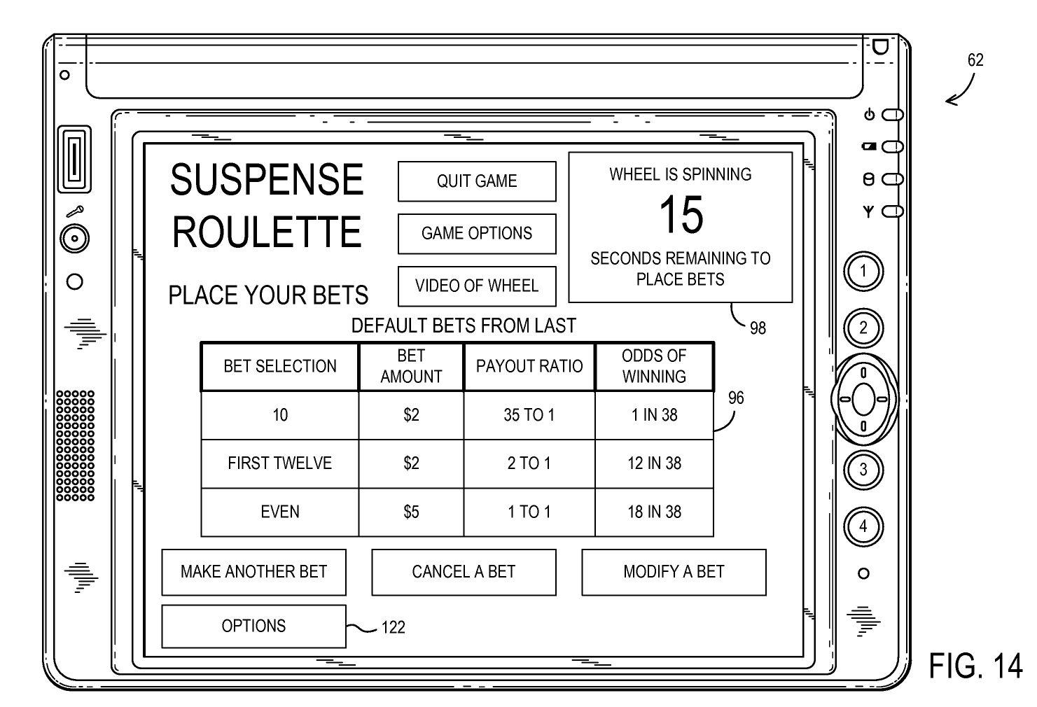

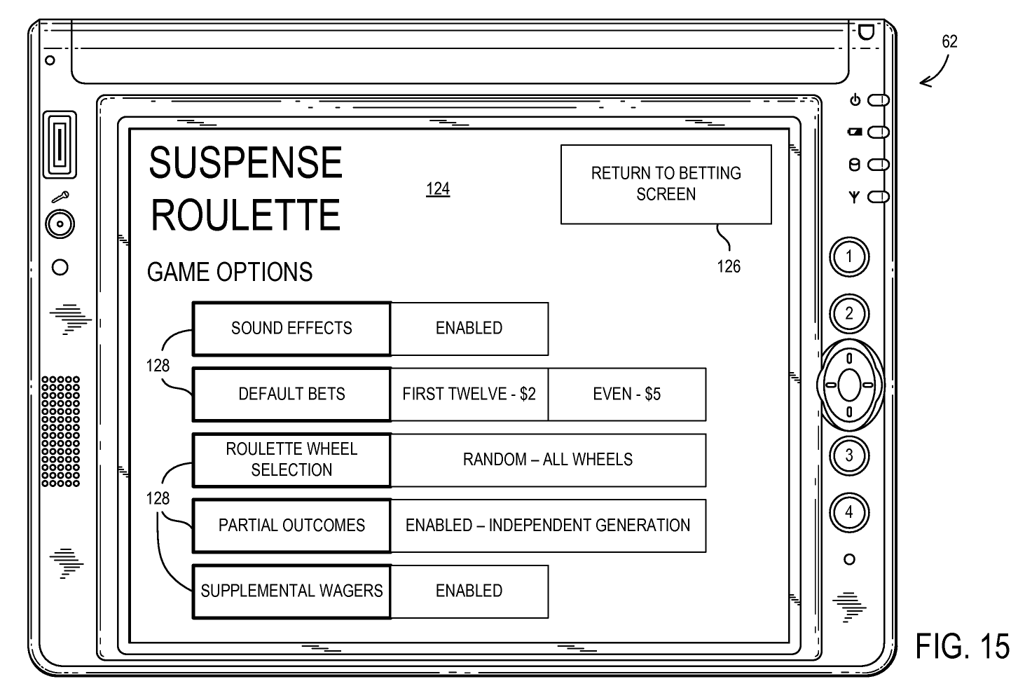

In an exemplary embodiment, the player remains associated with the same roulette table 16 that provided the immediately proceeding actual result. Thus, the player may be allowed to repeat or modify her wagers while being informed of how much time remains before the next game start. For example, a default set of bets 96 and a count down timer 98 may be displayed to the player as illustrated in FIG. 14. Likewise the player may be given the opportunity to change options through an options button 122. Activating the options button 122 may call up an options screen 124 as illustrated in FIG. 15. Note that the options screen 124 may have a return to betting screen button 126 as well as a plurality of option buttons 128. In the option screen, the player may turn on and off the partial results, turn on and off the supplemental wagers function or the like as desired. Likewise, the player may designate one or more default wagers. Still other options are possible, and the illustrated options are exemplary.

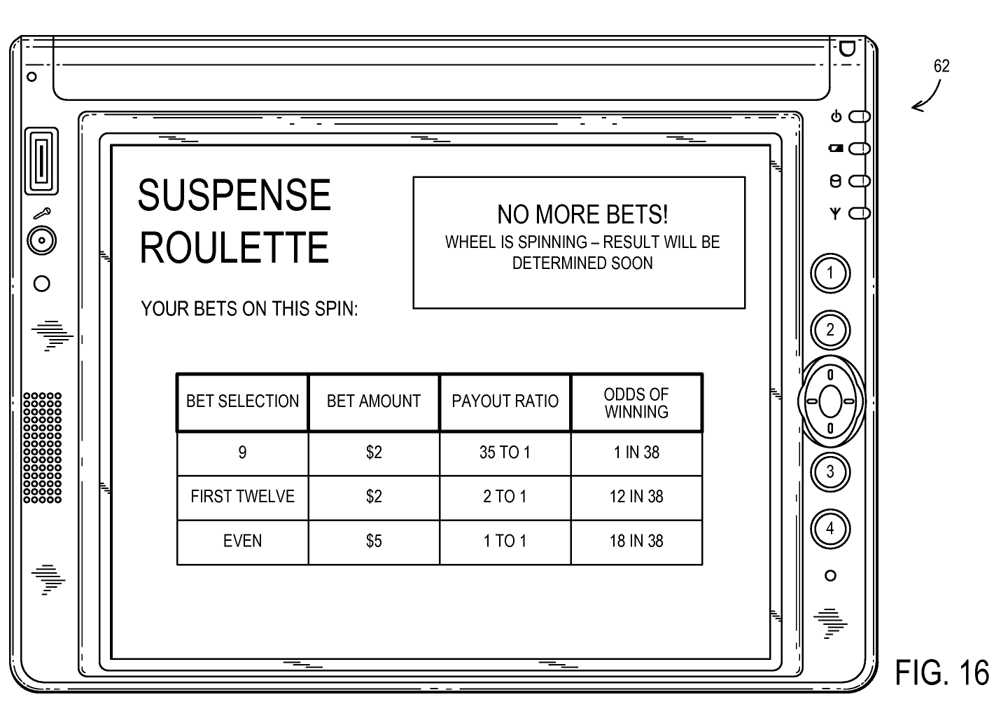

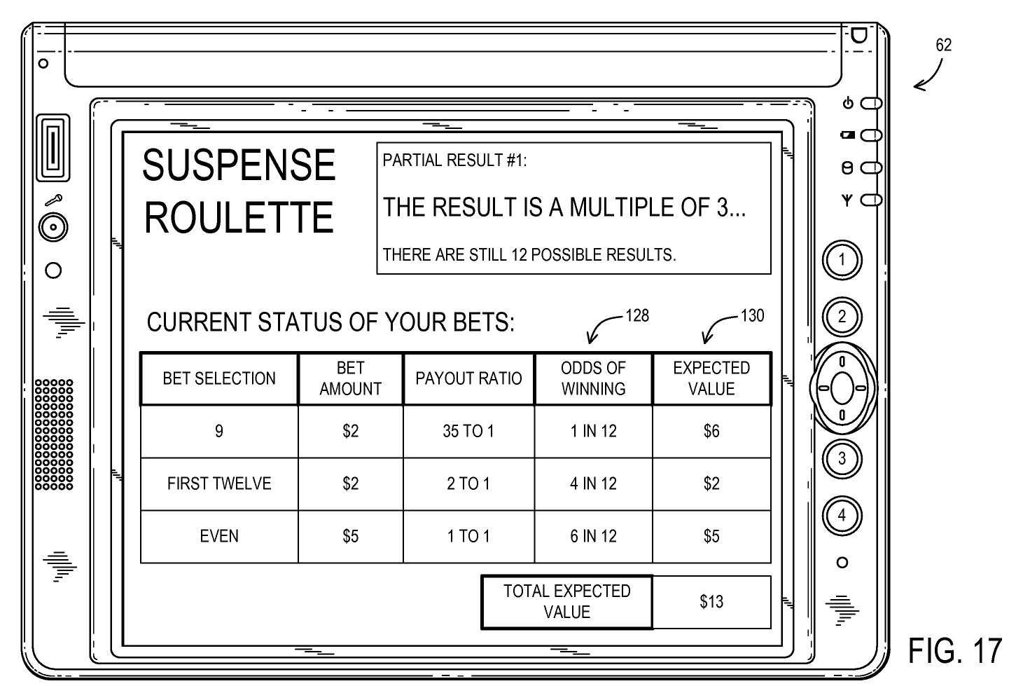

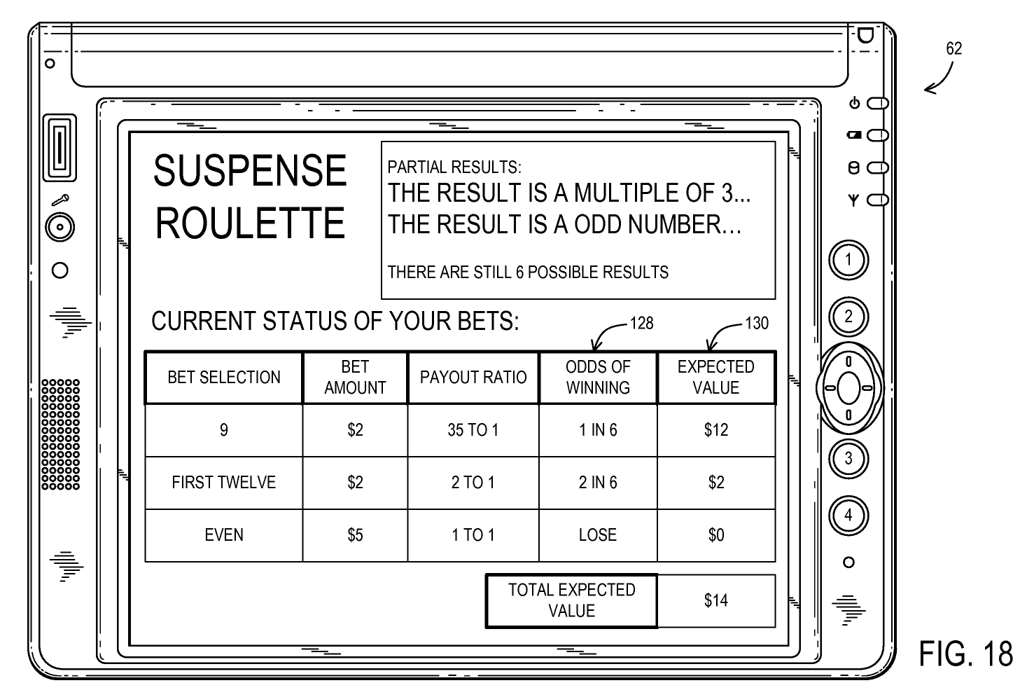

To illustrate the supplemental wager function, a series of exemplary screen shots are provided in FIGS. 16-23. As before, betting closes and the player is able to see her pending wagers as illustrated in FIG. 16. Here the player has wagered on 9, the first twelve, and even. The odds are also listed. The player is informed of the first partial result in FIG. 17. In this case, the first partial result is that the actual result is a multiple of three. This partial result is particularly effective because it does not definitively indicate whether any wager is a winning or losing wager. Rather, the player is informed of the updated odds 128 and the expected value 130 of the existing wagers. The player is informed of a second partial result in FIG. 18. Now the player knows that the number is odd and that the player's even wager is a losing wager. The player can see the updated odds 128 and expected value 130.

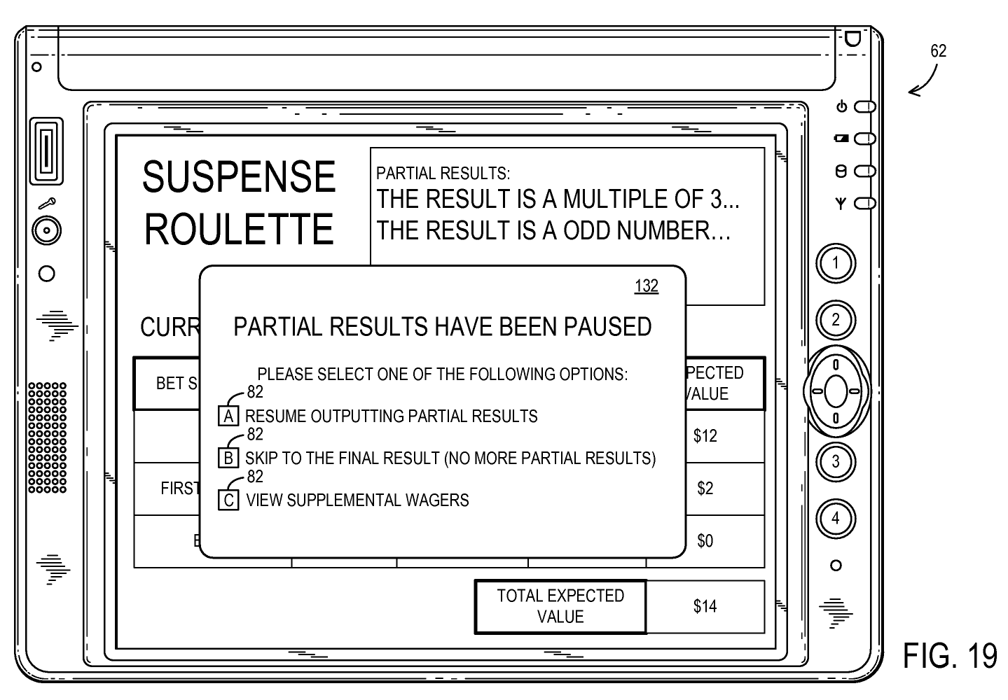

At this point, either automatically, or in response to a player command, the revelation of the partial results is paused as illustrated in FIG. 19 and the player is given several options via an in-game option screen 132, including resuming action, skipping to the final result, and viewing possible supplemental wagers. The player may select an option through use of the appropriate response button 82.

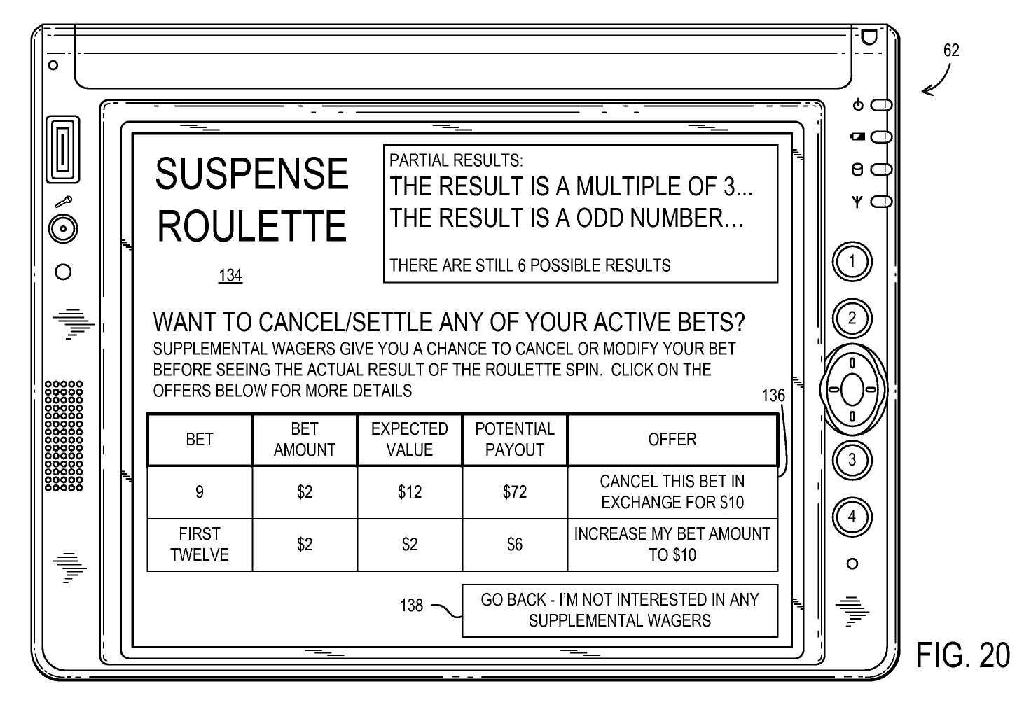

Assuming the player selects the supplemental wager function from the in-game option screen 132, the player is now presented a supplemental wager screen 134 as illustrated in FIG. 20. As used herein, the term supplemental wager is defined to be a wager initiated after a partial result is revealed which modifies, cancels, or adds to an existing wager. As used herein modifying a wager includes changing either an amount that is wagered or the outcome on which the wager is placed. For example, FIG. 20 illustrates modifying the amount of the “first twelve” wager from $2 to $10. Likewise, the player could be offered the chance to change the wager on the first twelve to the second twelve (not illustrated). As used herein canceling a wager includes accepting a sum certain (e.g., an expected value, an expected value minus a rake, the original wager amount (in effect treating the wager as a “push”), or the like) in exchange for closing or terminating the wager. That is, the player receives the sum certain and the wager ends, preventing the player from receiving any payout that would have been due based on the final outcome. In some embodiments, canceling a wager may be considered “settling” a wager in that the player “settles” or otherwise performs sufficient accounting to discharge both sides' outstanding possibilities for the wager.

As illustrated in FIG. 20, the player is asked if they wish to cancel or modify their wager before seeing the actual result. For example, if the player wishes to cancel her bet on the number 9, the player may touch the cancel button 136. Alternatively, the player can use the “Go Back” button 138 to return to the game.

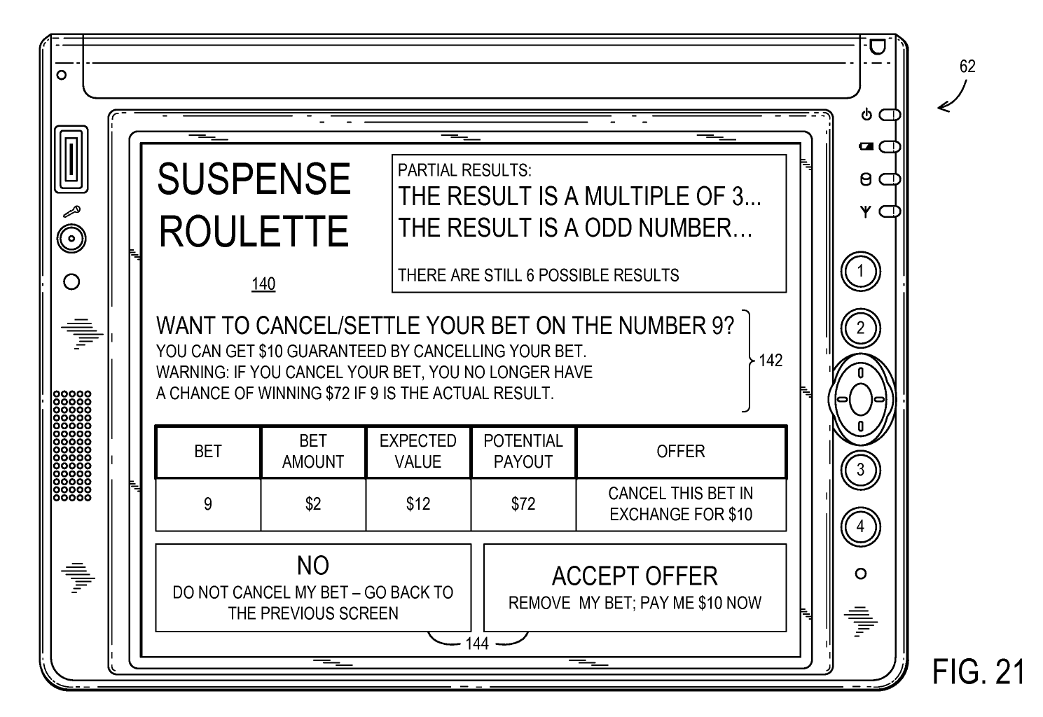

If the player touches the cancel button 136, another cancel screen 140 is provided as illustrated in FIG. 21. The cancel screen 140 provides an explanation 142 of what is being done as part of canceling the wager. The player may make her selection through the use of response buttons 144. Note that the cancel offer is less than the expected value previously displayed so that a house edge may be maintained.

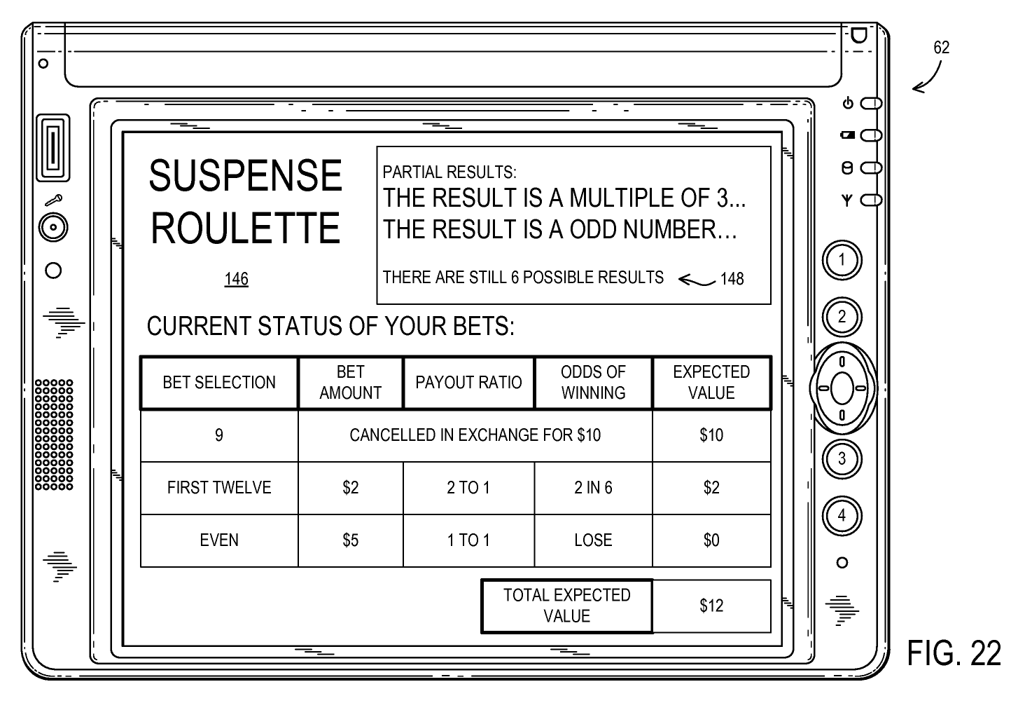

Assuming the player takes the cancel offer, the player may return to the game with an updated wager screen 146 as illustrated in FIG. 22. The even wager still reflects its losing status, and the nine wager reflects that it has been canceled in exchange for the cancel offer of $10. The first twelve wager is still active.

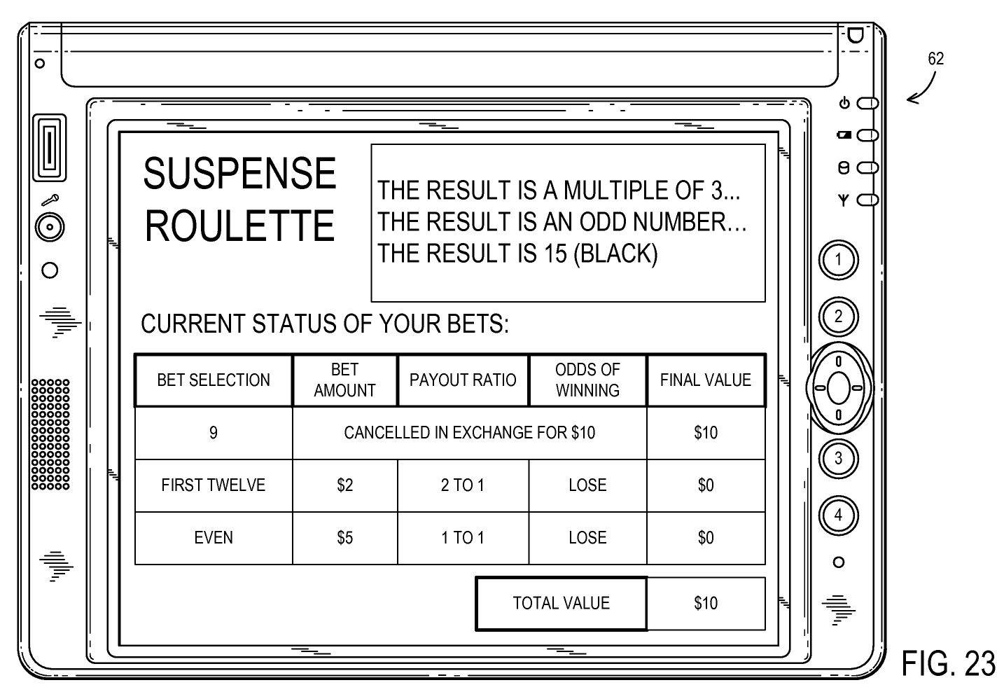

Finally, as illustrated in FIG. 23, the actual result is revealed to the player. The player knows that the first twelve is a losing wager and the accounting takes place to pay out the canceled wager and collect the losing wagers.

Note that while the embodiments described above with reference to FIGS. 6-23 contemplate using a mobile terminal 62, other player kiosks 40 or personal computers could be used if desired.

Note that while the screen shots provided have indicia thereon on explaining how may possible results remain (see indicia 148 in FIG. 22 and comparable indicia in other Figures), it is also possible that such information may be conveyed graphically. For example, an image of a betting felt or roulette wheel could be displayed with viable possible results lit up or otherwise highlighted. An additional example of such highlighting would be to color viable possible results one color and foreclosed results in a second color. Likewise, foreclosed results could be removed, dimmed, or grayed out, effectively highlighting the remaining viable possible results. Many permutations on this concept are included within the concepts of the present disclosure. Likewise, instead of explicitly telling the player that the partial result is “the actual result is even”, all odd numbers may be removed, dimmed, or grayed out. This change in the odd numbers conveys the same information as the explicit statement of the partial result. To this extent, partial results may be conveyed graphically rather than textually. Partial results could also be presented audibly through a speaker. These formats are not mutually exclusive and may be combined if desired.

Note also that instead of presenting the indicia 148 or partial results on the mobile terminal 62, the image may be presented on a central television or other video monitor. Similarly, the partial results and/or indicia 148 may be presented by scrolling text or other format as desired.

Further note that other screen shots and informational text and indicia may be used to help guide the player through the revelation of the partial result, actual result, supplemental wagers and the like. Drop down menus, window style menus or screen shots or the like may all be used as desired. The provided screen shots are illustrative only.

While the above discussion contemplates that partial results may be provided for each game start, it is possible that partial results may be provided in a percentage of game starts, only at the player's request, or only according to some other criteria. For example, the server may determine whether to output a partial result based on a random number, wherein the partial result is displayed only twenty percent (or other percentage) of the time. Another criterion is what the actual result is. For example, in one embodiment, if the actual result is zero or double zero, no partial results are ever displayed. The size of the player's bet may be a criterion. E.g., partial results are only presented if the player wagered more/less than fifty dollars. The size of the player's winnings may be a criterion. E.g., partial results are only presented if the player won more/less than one hundred dollars.

Still another criterion is based on timing. Display of partial results will extend the time it takes to present game results and may slow down game play. Thus, the control system may determine whether to present partial results based on the potential for slowing down game play excessively. For example, if there is not much time before the next game start, partial results may not be provided. Alternatively, if there is a lot of time before the next game start, partial results may be used. The relative time available calculations may be tied to historical information about a player's betting habits. For example, if a player historically takes twenty seconds to place her wagers and only thirty seconds remains before the next game start, partial results may be curtailed. If however, forty-five seconds remain before the next game start, partial results may be provided. Different thresholds may be provided for different players depending on play style, player preferences or the like. Bandwidth consumption may also be of concern and prevent usage of partial results. For example, if a relatively large number of mobile terminals 62 are in use, and sending partial results to that many mobile terminals 62 would noticeably degrade network performance, then the system may refrain from sending partial results.

In embodiments where two partial results are provided prior to provision of the actual result, the first and second partial results may be coordinated. For example, the second partial result may be selected based on the first partial result that was already output. The sequence of partial results may be determined before any of the partial results are presented to the player. Player feedback may be used to gauge a player's reaction to the first partial result and the second partial result may be based on the player feedback. For example, a camera, microphone, pulse rate monitor, heat sensor, or the like may be used to evaluate some criterion related to the player reaction and adjust the second partial result accordingly.

Use of partial results may be a function of player identity or player preferences. For example, a player may have indicated a preference for one, two, or more partial results in a player profile. Alternatively, all players above a certain number of points in the player rewards program may automatically receive a set number of partial results. Still other player information could be used as a criterion. For example, demographic information, player gaming history, player's current or past location, purchase by the player or the like all could be used to grant, withhold or set the number of partial results.

The nature of the partial result may be based on many things, including the criteria set forth above for why and how partial results are provided (size of bet, player preferences, etc.). Likewise, the partial result may be based on previous games, either previous wagers made by the player or previous results. For example, if the last three actual results have been even numbers, then the next partial result may indicate whether the result is even or odd. An example of the previous wager criterion would be that if a player won by betting on black in a first game start, then in a second game start, one of the first partial results is a red/black partial result. Under another consideration, if the last three games have had partial results indicating even/odd, then the player may be becoming bored with that information and the next partial result avoids duplicating the repetitive partial result and reveals different patterns or focuses on different information. In another embodiment, the partial result could be based on the odds or the potential payout of at least one wager. For example, the partial result could be selected so as to maintain the possibility that a player could win a payout over a certain threshold.

The selection of the partial result may be based on a random number. For example, a random number may be generated and compared to a table that indicates whether the partial result is related to an even/odd revelation, a red/black revelation, a low/high determination, a third determination, or the like. Separate random numbers may be used for each partial result or a single random number may determine what order a set of partial results are to be given.

While the above discussion has emphasized occluding the fact that all the player's wagers are losers because telling the player that all the wagers are losers prematurely may make the player lose interest before revelation of the actual result, in some embodiments, it may be desirable to reveal that at least one wager in a multi-wager game start is a loser. This revelation may increase the player's interest in subsequent partial results and revelation of the actual result. In a first embodiment, the largest wager is obfuscated until revelation of the actual result. In a second embodiment, the largest wager is revealed as a loser with the revelation of the first partial result. In a third embodiment, the smallest wager is obfuscated until revelation of the actual result. In a fourth embodiment, the smallest wager is revealed as a loser with the revelation of the first partial result. Other embodiments may change which wagers are revealed as losers at what stage. Selection of when to show a losing wager may be based on observing the player, player input (e.g., a player could request to have the largest wager obfuscated until revelation of the actual result), or other criterion as desired.

The partial results given to a first player may be based on the activities or wagers of a second player. That is, the same partial result may be output to a group of players who are betting on the same actual result. In this case, the partial result may be selected based on all the players' bets. Alternatively, different partial results may be output to different players, even if the players are making the same wagers, betting on the same roulette wheel or otherwise similarly linked. Players may be able to collaborate and determine the actual result. If supplemental wagers are used, such collaboration may be discouraged. However, absent supplemental wagers, such collaboration is irrelevant and may in fact be encouraged to develop a sense of camaraderie. In another permutation, the partial result may provide an indication that another player's wager is a winner/loser. Alternatively, supplemental information may be provided that leaves it uncertain if a specific wager for the second player is a winner or loser. For example, the supplemental information may state that “Fifty percent of Player Q's wagers are winners.” Still another permutation on this concept would be a comparison of relative success. “You have more winning wagers than player Q” or “You won more than player Q”.

As an interesting aside, whether or not the partial result is independent of the actual result has an effect on the odds of winning. If the partial result has been selected so as to not reveal that a player's bet is a winner or loser, then the partial result is not probabilistically independent, and the odds of winning or losing do not change. In contrast, if the partial result is selected independently of any bet placed by the player, then outputting the partial result will change the player's odds of winning. In such a case, information about the odds of winning or expected values may change. This result may seem counterintuitive, but this sort of “Monty Hall Problem” is explained in Haircut in Horse Town & Other Great Car Talk Puzzler, by Tom Magliozzi and Ray Magliozzi 1998, Diane Pub. Co. Further note that if outputting a partial result does not change a player's odds of winning, then it is possible to output statistics to the player, but may be worded so as not to mislead the player. Such statements may be phrased as a hypothetical or accompanied by a disclaimer.

As a permutation of the present disclosure, the player may request a video feed showing video clips of the spinning of the roulette wheel and which shows the actual result. The player may do this for the purpose of auditing the gaming establishment to make sure that the wagers the player made are resolved fairly. Likewise, there may be more robust auditing features provided. For example, an electronic audit trail of game results may be stored in a control system such as the control system of a table 36, the server 32 or other location. This audit information may cryptographically authenticate information such as: the time a player's wager is placed, the player's desired wager (indicating value, number selection, and roulette wheel), information about how a result is determined (e.g., which wheel is used to determine the result); information about how the wheel was chosen; the result; the time at which the result was generated; and similar information as desired. For more information about cryptographic techniques used to provide authentication of outcomes that are subsequently revealed to a player, the interested reader is directed to U.S. Pat. No. 6,099,408, which is hereby incorporated by reference in its entirety.

While the above discussion has focused on the player being remotely positioned from the roulette table 36 that provides the actual result, it is possible that the player may be proximate the associated roulette table 36. To prevent the player from looking at the table 36 and seeing the actual result before the player's mobile terminal 62 is finished disclosing the partial results, the gaming establishment may take steps to prevent the player from learning the actual result prior to viewing the result on the mobile terminal 62. In a simple embodiment, a physical cover such as a wood top or other mechanical cover may be positioned over the wheel of the roulette table 36. When the croupier is informed by the server 32 that the mobile terminal 62 has revealed the actual result, the croupier may remove the wood top/mechanical cover. Likewise a curtain or other partition may be used to keep the player from viewing the wheel of the table 36. Extending this concept, the associated table 36 may be in a separate room where players are not permitted. Extending this even further, the associated roulette table 36 is on a different property. For example, MGM may allow patrons of TI to bet on tables 36 positioned in the MIRAGE.

Still other techniques of preventing the player from viewing the table 36 may be used. For example, the mobile terminal 62 may be completely or partially deactivated when the mobile terminal 62 is within a certain distance (e.g., perhaps defined by line of sight) of the associated roulette table 36. The player may be prohibited from communicating with other casino patrons who are able to view the associated roulette table 36. This may be done by jamming or shielding cellular or other wireless communication signals or other technique as desired. More simply, patrons may be required to turn off wireless devices when they enter the pit where associated tables 36 are located. Casino personnel may remove individuals caught using wireless devices within the pit.

As yet another obfuscation technique, the player may simply not be informed of which table 36 is the associated table for that particular player. Still further, the associated table may change either periodically or randomly as desired to prevent the player from ascertaining which table corresponds to her associated table 36. In such embodiments, a more robust audit trail may be created so that the player can verify that the player is not being cheated by the gaming establishment retroactively declaring a particular table to be associated with the player in such a manner as to insure a loss.

Alternatively, in embodiments where supplemental wagers are not active, the gaming establishment may not care if the player can perceive the actual result prior to its revelation on the mobile terminal 62. That is, if there are no supplemental wagers, then the purpose of the partial results is to enhance the suspense of the game. If a player chooses to forego that enhanced suspense, that decision is the player's choice. Such a player may use the options menu to turn off partial results.

A variation in the accounting block 120 may be providing alternate currency prizes such as comp points, reduced room rates, tickets to the buffet or the like. Still other possible benefits or prizes may be awarded as desired.

### Partial Results for Non-Roulette

While the present disclosure is focused heavily on Roulette, the concepts disclosed herein can be extended to other games. It is known from U.S. Pat. Nos. 6,454,266 and 6,273,424 to allow a player to “plac[e] a wager comprising at least two distinct parts and providing to the player at least a portion of the total number of game elements used in the play of the game so that a partial evaluation of the player's game outcome in at least a single game is provided, giving the player at least one opportunity, before the player's complete set of game elements of final game outcome is determined, to withdraw from engagement in the game at least one part of said at least two parts . . . . ” Likewise, it is known from U.S. Patent Publication No. 2004/0219969 to “display[ ] the partial outcome of the wagering game [by] rotating and stopping at least two of a plurality of symbol-bearing reels to place symbols on the at least two of the plurality of symbol-bearing reels in the portion of the second array of symbols . . . . ” However, these references teach displays of partial outcomes, not partial results of actual results. The definitions of outcome, result, partial result and actual result provided above exclude such partial multi-element outcomes from being partial results. Applying the novel concepts to games like poker, blackjack, and slots, the partial result would be applied to individual results (as that term is defined above) within the game rather than the outcome. For example, applying the novel concepts to a card game, the actual result would be the full rank and suit of the card, and partial results would be color (red, black), face or numeric (e.g., ace or five), even, odd and the like. Thus, as the cards are dealt, each card would initially be dealt “face down” and the player may be informed “The first card is a black card; the first card is a spade, the first card is a five; the second card is a red card; the second card is a diamond; the second card is a six, etc.). The actual result for the first card is the fact that the first card is a five of spades. In this manner, each distinct actual result of the game may be revealed to the player as one or more partial results. Several actual results may then be combined into an outcome for the game. For slots, the partial results could be applied to each reel. For example, if the actual result for the first reel was that the symbol was a cherry, the partial results might be “the symbol is a fruit; the symbol is red, the symbol is a cherry.” In some instances, the partial result may be a negative. For example, “the symbol is not a bar” or the like.

### Other Alternate Embodiments

As another variation on the present disclosure, instead of displaying multiple partial results in sequence, the multiple partial results may be provided substantially contemporaneously. Furthermore, while it is expected that the partial results will provide additional information that theoretically allows the player to be better informed about the outcome, other forms of partial results are possible. If, for example, the first partial result is that the actual result is a multiple of four, then a second partial result that informs the player that the actual result is even does not provide any new information. However, such repetitive partial results are also contemplated.

Another variation would be to have the partial result be a false result. That is, information that it output to the player in a partial result may be false. This false information may be recanted via a later partial result or revelation of the actual result. Some players may find this form of revelation exciting.

Partial results may also be generated electronically and then combined to create an actual outcome.

While the above discussions have focused on single ball roulette, the concepts and thoughts of this disclosure may also be extended to multi-ball roulette. That is, several references teach versions of roulette that involve multiple roulette wheels, multiple spins of a roulette wheel, or multiple balls used in a single wheel. In either event, the actual results embodied in the plurality of balls allow for the determination of multiple random numbers. These multiple random numbers may then be combined to determine an outcome. Betting in such games may be a function of the multiple random numbers. The interested reader is directed to U.S. Pat. Nos. 6,890,255; 6,921,072; 6,497,409; 5,102,135; 5,755,440; and 5,934,999; and U.S Patent Publication No. 2006/066044, all of which are hereby incorporated by reference in their entireties.

### Rules of Interpretation

Numerous embodiments are described in this disclosure, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present disclosure is neither a literal description of all embodiments nor a listing of features of the invention that must be present in all embodiments.

Neither the Title (set forth at the beginning of the first page of this disclosure) nor the Abstract (set forth at the end of this disclosure) is to be taken as limiting in any way as the scope of the disclosed invention(s).

The term “product” means any machine, manufacture and/or composition of matter as contemplated by 35 U.S.C. §101, unless expressly specified otherwise.

The terms “an embodiment”, “embodiment”, “embodiments”, “the embodiment”, “the embodiments”, “one or more embodiments”, “some embodiments”, “one embodiment” and the like mean “one or more (but not all) disclosed embodiments”, unless expressly specified otherwise.

The terms “the invention” and “the present invention” and the like mean “one or more embodiments of the present invention.”

A reference to “another embodiment” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The terms “a”, “an” and “the” mean “one or more”, unless expressly specified otherwise.

The term “plurality” means “two or more”, unless expressly specified otherwise.

The term “herein” means “in the present disclosure, including anything which may be incorporated by reference”, unless expressly specified otherwise.

The phrase “at least one of”, when such phrase modifies a plurality of things (such as an enumerated list of things) means any combination of one or more of those things, unless expressly specified otherwise. For example, the phrase at least one of a widget, a car and a wheel means either (i) a widget, (ii) a car, (iii) a wheel, (iv) a widget and a car, (v) a widget and a wheel, (vi) a car and a wheel, or (vii) a widget, a car and a wheel.

The phrase “based on” does not mean “based only on”, unless expressly specified otherwise. In other words, the phrase “based on” describes both “based only on” and “based at least on”.

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to the limitation (e.g., “the widget”), this does not imply that the first claim covers only one of the feature, and this does not imply that the second claim covers only one of the feature (e.g., “the widget” can cover both one widget and more than one widget).

Each process (whether called a method, algorithm or otherwise) inherently includes one or more steps, and therefore all references to a “step” or “steps” of a process have an inherent antecedent basis in the mere recitation of the term ‘process’ or a like term. Accordingly, any reference in a claim to a ‘step’ or ‘steps’ of a process has sufficient antecedent basis.

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When a single device or article is described herein, more than one device or article (whether or not they cooperate) may alternatively be used in place of the single device or article that is described. Accordingly, the functionality that is described as being possessed by a device may alternatively be possessed by more than one device or article (whether or not they cooperate).

Similarly, where more than one device or article is described herein (whether or not they cooperate), a single device or article may alternatively be used in place of the more than one device or article that is described. For example, a plurality of computer-based devices may be substituted with a single computer-based device. Accordingly, the various functionality that is described as being possessed by more than one device or article may alternatively be possessed by a single device or article.

The functionality and/or the features of a single device that is described may be alternatively embodied by one or more other devices that are described but are not explicitly described as having such functionality and/or features. Thus, other embodiments need not include the described device itself, but rather can include the one or more other devices which would, in those other embodiments, have such functionality/features.

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

A description of an embodiment with several components or features does not imply that all or even any of such components and/or features are required. On the contrary, a variety of optional components are described to illustrate the wide variety of possible embodiments of the present invention(s). Unless otherwise specified explicitly, no component and/or feature is essential or required.

Further, although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

Although a process may be described as including a plurality of steps, that does not indicate that all or even any of the steps are essential or required. Various other embodiments within the scope of the described invention(s) include other processes that omit some or all of the described steps. Unless otherwise specified explicitly, no step is essential or required.

Although a product may be described as including a plurality of components, aspects, qualities, characteristics and/or features, that does not indicate that all of the plurality are essential or required. Various other embodiments within the scope of the described invention(s) include other products that omit some or all of the described plurality.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise. For example, the enumerated list “a computer, a laptop, a PDA” does not imply that any or all of the three items of that list are mutually exclusive and does not imply that any or all of the three items of that list are comprehensive of any category.

Headings of sections provided in this disclosure are for convenience only, and are not to be taken as limiting the disclosure in any way.

A player “wagers” at least a single “unit of wager” to pay for a game start. In many gaming devices, a unit of wager may be referred to as a credit. Many gaming devices allow multiple credits to be wagered concurrently in exchange for an improved paytable or more paylines. A unit of wager may be equivalent to a full dollar amount ($1, $5), a fractional dollar amount, a coin (e.g., $0.05 (nickel) or $0.25 (quarter)), or specified amount of another currency (e.g., a specified number of comp points). Some paytables may be expressed as a number of coins won relative to a number of coins wagered. In such instances, the term coin is the same as a unit of wager. Because gaming devices are embodied in different denominations, it is relevant to note that a coin, credit, or unit of wager on a first device may not be identically valued as a coin, credit, or unit of wager on a second device. For example, a credit on a quarter slot machine (on which the credit is equivalent to $0.25) is not the same as a credit on a five dollar slot machine (on which the credit is equivalent to $5.00). Accordingly, it should be understood that in embodiments in which a player may cash out credits from a first gaming device that operates based on a first denomination (e.g., a quarter-play slot machine) and establish, using only the cashed out credits, a credit balance on a second gaming device that operates based on a second denomination (e.g., a nickel-play slot machine), the player may receive a different number of credits on the second gaming device than the number of credits cashed out at the first gaming device. An interesting discussion of this concept can be found in U.S. Pat. No. 5,277,424, which is hereby incorporated by reference in its entirety.

“Determining” something can be performed in a variety of manners and therefore the term “determining” (and like terms) includes calculating, computing, deriving, looking up (e.g., in a table, database or data structure), ascertaining, recognizing, and the like.

A “display” as that term is used herein is an area that conveys information to a viewer. The information may be dynamic, in which case, an LCD, LED, CRT, LDP, rear projection, front projection, or the like may be used to form the display. The aspect ratio of the display may be 4:3, 16:9, or the like. Furthermore, the resolution of the display may be any appropriate resolution such as 480i, 480p, 720p, 1080i, 1080p or the like. The format of information sent to the display may be any appropriate format such as standard definition (SDTV), enhanced definition (EDTV), high definition (HD), or the like. The information may likewise be static, in which case, painted glass may be used to form the display. Note that static information may be presented on a display capable of displaying dynamic information if desired.

The present disclosure frequently refers to a “control system”. A control system, as that term is used herein, may be a computer processor coupled with an operating system, device drivers, and appropriate programs (collectively “software”) with instructions to provide the functionality described for the control system. The software is stored in an associated memory device (sometimes referred to as a computer readable medium). While it is contemplated that an appropriately programmed general purpose computer or computing device may be used, it is also contemplated that hard-wired circuitry or custom hardware (e.g., an application specific integrated circuit (ASIC)) may be used in place of, or in combination with, software instructions for implementation of the processes of various embodiments. Thus, embodiments are not limited to any specific combination of hardware and software.

A “processor” means any one or more microprocessors, CPU devices, computing devices, microcontrollers, digital signal processors, or like devices. Exemplary processors are the INTEL PENTIUM or AMD ATHLON processors.

The term “computer-readable medium” refers to any medium that participates in providing data (e.g., instructions) that may be read by a computer, a processor or a like device. Such a medium may take many forms, including but not limited to, non-volatile media, volatile media, and transmission media. Non-volatile media include, for example, optical or magnetic disks and other persistent memory. Volatile media include DRAM, which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during RF and IR data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, a USB memory stick, a dongle, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols. For a more exhaustive list of protocols, the term “network” is defined below and includes many exemplary protocols that are also applicable here.

It will be readily apparent that the various methods and algorithms described herein may be implemented by a control system and/or the instructions of the software may be designed to carry out the processes of the present invention.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models, hierarchical electronic file structures, and/or distributed databases) could be used to store and manipulate the data types described herein. Likewise, object methods or behaviors of a database can be used to implement various processes, such as those described herein. In addition, the databases may, in a known manner, be stored locally or remotely from a device that accesses data in such a database. Furthermore, while unified databases may be contemplated, it is also possible that the databases may be distributed and/or duplicated amongst a variety of devices.

As used herein a “network” is an environment wherein one or more computing devices may communicate with one another. Such devices may communicate directly or indirectly, via a wired or wireless medium such as the Internet, LAN, WAN or Ethernet (or IEEE 802.3), Token Ring, or via any appropriate communications means or combination of communications means. Exemplary protocols include but are not limited to: Bluetooth™, TDMA, CDMA, GSM, EDGE, GPRS, WCDMA, AMPS, D-AMPS, IEEE 802.11 (WI-FI), IEEE 802.3, SAP, SAS™ by IGT, OASIS™ by Aristocrat Technologies, SDS by Bally Gaming and Systems, ATP, TCP/IP, gaming device standard (GDS) published by the Gaming Standards Association of Fremont Calif., the best of breed (BOB), system to system (S2S), or the like. Note that if video signals or large files are being sent over the network, a broadband network may be used to alleviate delays associated with the transfer of such large files, however, such is not strictly required. Each of the devices is adapted to communicate on such a communication means. Any number and type of machines may be in communication via the network. Where the network is the Internet, communications over the Internet may be through a website maintained by a computer on a remote server or over an online data network including commercial online service providers, bulletin board systems, and the like. In yet other embodiments, the devices may communicate with one another over RF, cable TV, satellite links, and the like. Where appropriate encryption or other security measures such as logins and passwords may be provided to protect proprietary or confidential information.

Communication among computers and devices may be encrypted to insure privacy and prevent fraud in any of a variety of ways well known in the art. Appropriate cryptographic protocols for bolstering system security are described in Schneier, APPLIED CRYPTOGRAPHY, PROTOCOLS, ALGORITHMS, AND SOURCE CODE IN C, John Wiley & Sons, Inc. 2d ed., 1996, which is incorporated by reference in its entirety.

The present disclosure provides, to one of ordinary skill in the art, an enabling description of several embodiments and/or inventions. Some of these embodiments and/or inventions may not be claimed in the present disclosure, but may nevertheless be claimed in one or more continuing applications that claim the benefit of priority of the present disclosure.

What is claimed is:

1. A method comprising:
determining an actual result of a game of chance;
determining a first partial result based on the actual result;
outputting information about the first partial result to a player of the game of chance; and
outputting an indication of the actual result, wherein outputting the information of the actual result is distinct from outputting the indication of the first partial result.

2. The method of claim 1 wherein outputting information comprises outputting information that informs the player of a characteristic of the actual result without revealing the actual result.

3. The method of claim 1 wherein the actual result is a function of a single random event.

4. The method of claim 1 wherein the actual result is not a complete outcome for the game of chance.

5. The method of claim 1 further comprising outputting an outcome.

6. The method of claim 5 wherein outputting the outcome is different than outputting the indication of the actual result.

7. The method of claim 5 wherein outputting the indication of the actual results effectively outputs the outcome.

8. The method of claim 1 wherein the game of chance comprises at least one of: craps and roulette.

9. The method of claim 1 wherein outputting information comprises outputting information on a mobile terminal.

10. The method of claim 1 further comprising receiving a wager from the player.

11. The method of claim 10 wherein determining the first partial result comprises determining the first partial result at least in part on the wager.

12. The method of claim 11 wherein outputting information about the first partial result comprises revealing selected information about the first partial result such that the player is informed of a characteristic of the actual result without being aware of whether the wager is a winning wager.

13. The method of claim 11 further comprising allowing the player to select from a plurality of games of chance from which the player places the wager.

14. The method of claim 1 further comprising determining a second partial result and outputting second information about the second partial result.

15. The method of claim 1 wherein determining the actual result of the game of chance comprises determining the actual result of a game of chance at a physical table game.

16. The method of claim 1 wherein determining the actual result of the game of chance comprises determining the actual result of a game of chance at an electronic table game.

17. The method of claim 1 wherein outputting information comprises outputting a plurality of potential actual results and selectively removing at least one potential result from the plurality.

18. The method of claim 1 wherein outputting information comprises outputting information on a fixed player station.

19. The method of claim 1 further comprising temporarily concealing the actual result from the player.

20. The method of claim 19 wherein temporarily concealing comprising temporarily obscuring the actual result with a mechanical cover.

21. The method of claim 1 further comprising determining whether to output the first partial result.

22. The method of claim 1 further comprising outputting supplemental information.

23. The method of claim 22 wherein outputting supplemental information comprises outputting statistical information relating to a number of successful wagers made by the player without revealing which particular wagers were successful.

24. A system comprising:
a user interface adapted to accept wagers from a player on a game of chance; and
a control system operatively coupled to the user interface and adapted to:
determine an actual result of the game of chance, wherein the actual result is a function of a single random event;
determine a first partial result based on the actual result; and
output, through the user interface, information about the first partial result to a player of the game of chance; and
output an indication of the actual result, wherein outputting the information is distinct from outputting the indication.

25. The system of claim 24 wherein the user interface comprises a mobile terminal and the control system comprises a central server.

26. A computer readable medium comprising software with instructions to:
determine an actual result of a game of chance, wherein the actual result is a function of a single random event;
determine a first partial result based on the actual result; and
output information about the first partial result to a player of the game of chance; and
output an indication of the actual result, wherein outputting the information is distinct from outputting the indication.

27. A method comprising:
providing a plurality of gaming devices of a same type;
receiving a wager from a player to be placed on a gaming device of the same type;
determining an outcome at the gaming device;
preventing the player from determining which gaming device on which the wager is placed; and
outputting the outcome to the player.

28. The method of claim 27 further comprising informing the player which gaming device on which the wager was placed.

29. The method of claim 28 wherein informing the player which gaming device on which the wager was placed occurs after the wager is placed by the player.

30. The method of claim 27 wherein the plurality of gaming devices of the same type comprise gaming devices comprising at least one of: craps tables, roulette tables, electronic craps tables, or electronic roulette tables.

31. The method of claim 27 wherein receiving the wager comprises receiving the wager from a mobile terminal.

32. The method of claim 27 further comprising determining which of the plurality of gaming devices of the same type is to be the gaming device at which the outcome is determined.

33. The method of claim 32 wherein determining which of the plurality of gaming devices is to be the gaming device at which the outcome if determined comprises determining at a central server.

34. The method of claim 27 wherein preventing the player from determining which gaming device on which the wager is placed comprises preventing the player from determining until after the player has placed the wager.

35. The method of claim 27 further comprising providing audit information such that the player may determine on which gaming device from amongst the plurality of gaming devices the wager was placed.

36. A method comprising:
providing a plurality of gaming devices of a same type;
receiving a wager from a player to be placed on a gaming device of the same type;
determining an actual result at the gaming device;
not informing the player as to which gaming device on which the wager is placed; and
outputting the actual result to the player.

37. A system comprising:
a user interface; and
a control system operatively coupled to the user interface and adapted to:
communicate with a plurality of gaming devices of a same type;
receive, through the user interface, a wager from a player to be placed on a gaming device of the same type;
determine an outcome at the gaming device;
prevent the player from determining which gaming device on which the wager is placed; and
output the outcome to the player.

38. The system of claim 37 wherein the user interface comprises a mobile terminal.

39. The system of claim 37 wherein the control system is embodied in a central server.

40. A computer readable medium comprising software with instructions to:
communicate with a plurality of gaming devices of a same type;
receive a wager from a player to be placed on a gaming device of the same type;
determine an outcome at the gaming device;
prevent the player from determining which gaming device on which the wager is placed; and
output the outcome to the player.

41. A method comprising:
receiving an indication of a wager from a player on a game start of roulette;
determining an actual result associated with the game start of roulette;
before revealing the result to the player, determining whether to present a supplemental wager opportunity to the player;
outputting partial information relating to the actual result to the player; and
receiving a supplemental wager from the player based on the supplemental wager opportunity.

42. The method of claim 41 wherein the partial information comprises a partial result.

43. The method of claim 41 wherein outputting partial information comprises outputting information without revealing the actual result.

44. The method of claim 41 wherein outputting partial information to the player comprises outputting partial information through a mobile terminal.

45. The method of claim 41 further comprising outputting the actual result to the player.

46. The method of claim 41 further comprising presenting the supplemental wager opportunity to the player.

47. The method of claim 46 wherein presenting the supplemental wager opportunity comprises presenting an opportunity to change the wager.

48. The method of claim 46 wherein presenting the supplemental wager opportunity comprises presenting an opportunity to add to the wager.

49. The method of claim 46 wherein presenting the supplemental wager opportunity comprises presenting an opportunity to make an additional wager.

50. The method of claim 46 wherein presenting the supplemental wager opportunity comprises presenting the player an opportunity to cancel the wager.

51. The method of claim 50 wherein presenting the player the opportunity to cancel the wager comprises presenting the player the opportunity to cancel the wager based at least in part on an expected value.

52. The method of claim 41 wherein determining whether to present the supplemental wager opportunity to the player is based at least in part on the wager from the player.

53. The method of claim 52 wherein determining whether to present the supplemental wager opportunity to the player is further based at least in part on the result.

54. The method of claim 41 further comprising determining a parameter of the supplemental wager opportunity.

55. The method of claim 54 wherein determining the parameter of the supplemental wager opportunity is based at least in part on the wager from the player.

56. The method of claim 54 wherein determining the parameter of the supplemental wager opportunity is based at least in part on the result.

57. A system comprising:
a user interface;
a control system operatively coupled to the user interface and adapted to:
receive an indication of a wager from a player on a game start of roulette;
determining a result associated with the game start of roulette;
before revealing the result to the player, determine whether to present a supplemental wager opportunity to the player;
output partial information relating to the result to the player; and
receive a supplemental wager from the player base don the supplemental wager opportunity.

58. The system of claim 57 wherein the user interface comprises a mobile terminal.

59. The system of claim 57 wherein the control system comprises a central server.

60. A computer readable medium comprising software with instructions to:
receive an indication of a wager from a player on a game start of roulette;
determine a result associated with the game start of roulette;
before revealing the result to the player, determine whether to present a supplemental wager opportunity to the player;
output partial information relating to the result to the player; and
receive a supplemental wager from the player base don the supplemental wager opportunity.

61. A method comprising:
accepting a wager from a player on a game start of a roulette game;
determining an actual result for the game start of the roulette game;
determining a partial result for the game start based on the actual result;
initially providing first information about the partial result to the player; and
subsequently providing second information about the actual result to the player.

62. The method of claim 61 wherein determining the partial result comprises evaluating the wager to determine what sorts of first information will infer the actual result while obfuscating whether the wager is a winning wager.

63. The method of claim 61 wherein accepting the wager comprises accepting the wager through a mobile terminal.

64. A method comprising:
accepting a wager from a player wherein the wager reflects one of a plurality of possible outcomes of a game of chance;
determining which of the plurality of possible outcomes is a winning outcome;
determining a characteristic of the winning outcome;
informing the player of the characteristic such that the player may learn more about the winning outcome without knowing what the winning outcome is; and
informing the player of the winning outcome.
